(19) United States
(12) Patent Application Publication
(10) Pub. No.: US 2025/0077237 A1
(43) Pub. Date: Mar. 6, 2025

(54) GAI TO APP INTERFACE ENGINE

(71) Applicant: Microsoft Technology Licensing, LLC, Redmond, WA (US)

(72) Inventors: Santhosh Sachindran, Campbell, CA (US); Barkha A. Bhojak, Smyrna, GA (US); Nicholas Smith, Walnut Creek, CA (US); Eric Bollman, Sherman Oaks, CA (US); Jeffrey Wang, San Francisco, CA (US); Tamara Llosa-Sandor, Pasadena, CA (US); Carlos H. Lopez, Westfield, NJ (US)

(21) Appl. No.: 18/459,233

(22) Filed: Aug. 31, 2023

(51) Int. Cl. G06F 9/445; G06N 3/0475

(52) U.S. Cl. CPC G06F 9/445; G06N 3/0475

(57) ABSTRACT

Embodiments of the disclosed technologies include, responsive to a first use of a first application by a first user, configuring, in a first prompt, at least one instruction based on first application context data and first user context data. The first prompt is stored in a memory that is accessible to the first application and a second application. Via the second application, first output of a generative artificial intelligence (GAI) model is presented to the first user. Based on the first output of the GAI model, at least one second use of the first application by the first user, or at least one first use of a third application by the first user, is configured.

### TECHNICAL FIELD

A technical field to which this disclosure relates includes online systems, such as content distribution systems and information retrieval systems. Another technical field to which this disclosure relates includes computer programs that use artificial intelligence to automate responses to user requests for information in a manner that simulates human conversation. Another technical field to which the present disclosure relates is generative artificial intelligence.

### COPYRIGHT NOTICE

This patent document, including the accompanying drawings, contains material that is subject to copyright protection. The copyright owner has no objection to the facsimile reproduction of this patent document, as it appears in the publicly accessible records of the United States Patent and Trademark Office, consistent with the fair use principles of the United States copyright laws, but otherwise reserves all copyright rights whatsoever.

### BACKGROUND

A content distribution system is a computer system that is designed to distribute digital content items, such as posts, articles, videos, images, and job postings, to computing devices for viewing and interaction by users of those devices. Examples of content distribution systems include news feeds, social network services, messaging systems, and search engines. A chatbot (or chat bot) is a software application that can retrieve information and answer questions by simulating a natural language conversation with a human user.

### BRIEF DESCRIPTION OF THE DRAWINGS

The disclosure will be understood more fully from the detailed description given below and from the accompanying drawings of various embodiments of the disclosure. The drawings are for explanation and understanding only and should not be taken to limit the disclosure to the specific embodiments shown.

FIG. 1 is a flow diagram of an example method for managing communications among one or more applications and a generative artificial intelligence model using components of an interface engine in accordance with some embodiments of the present disclosure.

FIG. 2 is a flow diagram of an example method for managing communications among one or more applications and a generative artificial intelligence model using components of an interface engine in accordance with some embodiments of the present disclosure.

FIG. 3 is a flow diagram of an example method for configuring one or more contextual instructions to be included in a prompt for a generative artificial intelligence model using components of an interface engine in accordance with some embodiments of the present disclosure.

FIG. 4A illustrates an example of at least one flow including screen captures of user interface screens configured to facilitate communications between or among one or more applications and a generative artificial intelligence model using components of an interface engine in accordance with some embodiments of the present disclosure.

FIG. 4B illustrates an example of at least one flow including screen captures of user interface screens configured to facilitate communications between or among one or more applications and a generative artificial intelligence model using components of an interface engine in accordance with some embodiments of the present disclosure.

FIG. 5 illustrates an example of at least one flow including screen captures of user interface screens configured to facilitate communications between or among one or more applications and a generative artificial intelligence model using components of an interface engine in accordance with some embodiments of the present disclosure.

FIG. 6 is a block diagram of a computing system that includes an interface engine in accordance with some embodiments of the present disclosure.

FIG. 7 is a flow diagram of an example method for providing an interface between or among one or more applications and a generative artificial intelligence model using components of an interface engine in accordance with some embodiments of the present disclosure.

FIG. 8 is a block diagram of an example computer system including components of a an interface engine in accordance with some embodiments of the present disclosure.

### DETAILED DESCRIPTION

It is often human nature to resist change. It is not surprising, then, that large segments of the population may resist or be slow to adopt new technologies, even if they are aware of the potential benefits. These natural human inclinations can result in the under-utilization of beneficial software features. Therefore, it is a continuing technical challenge for software engineers to introduce new technologies to their user base in a way that facilitates adoption and use through high-quality user experiences.

Due to these and other issues, generative artificial intelligence is an example of a technology that may face challenges to widespread adoption in the broad consumer markets.

A generative artificial intelligence (GAI) model or generative model uses artificial intelligence technology, e.g., neural networks, to machine-generate new digital content based on model inputs and the previously existing data with which the model has been trained. Whereas discriminative models are based on conditional probabilities P (y|x), that is, the probability of an output y given an input x (e.g., is this a photo of a dog?), generative models capture joint probabilities P (x, y), that is, the likelihood of x and y occurring together (e.g., given this photo of a dog and an unknown person, what is the likelihood that the person is the dog's owner, Sam?).

A generative language model is a particular type of GAI model that generates new text in response to model input. The model input includes a task description, also referred to as a prompt. The task description can include instructions and/or examples of digital content. A task description can be in the form of natural language text, such as a question or a statement, and can include non-text forms of content, such as digital imagery and/or digital audio.

Given a task description, a generative model can generate a set of task description-output pairs, where each pair contains a different output. In some implementations, the generative model assigns a score to each of the generated task description-output pairs. The output in a given task description-output pair contains text that is generated by the model itself rather than provided to the model as an input. The score associated by the model with a given task description-output pair represents a probabilistic or statistical likelihood of there being a relationship between the output and the corresponding task description in the task description-output pair. The score for a given task description-output pair is dependent upon the way the generative model has been trained and the data used to perform the model training. The generative model can sort the task description-output pairs by score and output only the pair or pairs with the top scores. For example, the generative model could discard the lower-scoring pairs and only output the top-scoring pair as its final output.

A large language model (LLM) is a type of generative language model that is trained in an unsupervised way on massive amounts of unlabeled data, such as publicly available texts extracted from the Internet, using deep learning techniques. A large language model can be configured to perform one or more natural language processing (NLP) tasks, such as generating text, classifying text, answering questions in a conversational manner, and translating text from one language to another.

Generative models such as large language models are capable of answering questions in a conversational manner. Due to having been trained on extensive amounts of data, large language models are also capable of operating conversational online dialogs over a wide range of topics. Thus, large language models have the potential to improve the performance of many application software systems. However, large language models have the technical problem of hallucination. In artificial intelligence, a hallucination is often defined as generated content that is nonsensical or unfaithful to the provided source content. In long or multi-threaded dialogs, the risk of AI hallucination is increased with each round of dialog or thread provided to the LLM. For example, the risk of AI hallucination may increase when the user switches among multiple different applications within the same login session.

As a result of these and other issues, a technical challenge is to incorporate the use of LLMs and/or other GAI models into the operational flows of application software systems while mitigating the risk of AI hallucination and overcoming user resistance to new technologies.

Another technical challenge is how to reduce the burden of user input when processing and responding to user interactions across multiple different applications. For example, it can be challenging for online systems to retain content and/or contextual data during transitions between different applications or among different chats of the same application, all while maintaining the low latency expected by users of those systems. This aspect is especially challenging when the different applications provide different functionalities but the sharing of certain data permitted to be shared across application boundaries or across chat boundaries would be helpful to, for example, inform suggestions or other content generated by a different application or chat. For instance, the ability to carry over contextual information across multiple chats, within the same application or across different applications, significantly improves the chats' efficiency and effectiveness in responding to user requests.

Yet another technical challenge is how to scale a GAI-based system across multiple different applications and/or to a large number of users (e.g., hundreds of thousands to millions or more users) without needing to increase the size of the GAI-based system linearly. An additional technical challenge is how to configure a GAI-based system efficiently over a variety of application software systems and user devices, e.g., adapting the inputs to and outputs of the GAI-based system to different applications and/or to different form factors of user devices, e.g., different sizes of display screens, different device types, different operating systems, etc. A further technical challenge is how to respond to latency issues while integrating a GAI-based system with multiple different software applications.

To address these and other technical challenges, the disclosed technologies provide an interface engine that facilitates and manages communications, including communications of instructions and relevant contextual data, between or among multiple different apps, e.g., application software systems, including one or more GAI-based systems, where the one or more GAI-based systems include or are communicatively connected with one or more GAI models. The disclosed technologies are also or alternatively applicable to managing communications across multiple chats within the same application. As described in more detail below, embodiments of the disclosed interface engine address the above and other challenges via one or more of an icon handler, a context switcher, a state tracker and/or a contextual data fetcher.

Certain aspects of the disclosed technologies are described in the context of generative artificial intelligence models that output pieces of writing, i.e., natural language text. However, the disclosed technologies are not limited to generative models that produce text output. For example, aspects of the disclosed technologies can be used to generate output that includes non-text forms of output generated by one or more GAI models, such as digital imagery, videos, multimedia, audio, hyperlinks, and/or platform-independent file formats.

Certain aspects of the disclosed technologies are described in the context of electronic dialogs conducted via a network with at least one application software system, such as an instant messaging service, a chatbot, or a social network service. However, aspects of the disclosed technologies are not limited to instant messaging services, chatbots, or social network services, but can be used to improve the management of communications between or among various types of software applications and one or more GAI-based systems. Any network-based application software system can act as an application software system or GAI-based system to which the disclosed technologies can be applied. For example, news, entertainment, and e-commerce apps installed on mobile devices, enterprise systems, messaging systems, notification systems, search engines, workflow management systems, collaboration tools, and social graph-based applications can all function as application software systems or GAI-based systems with which the disclosed technologies can be used.

The disclosure will be understood more fully from the detailed description given below, which references the accompanying drawings. The detailed description of the drawings is for explanation and understanding, and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains, but can be used with or incorporated into other embodiments, including embodiments shown in other drawings.

As used herein, dialog, chat, or conversation may refer to one or more conversational threads involving a user of a computing device and an application software system. For example, a dialog or conversation can have an associated user identifier, session identifier, conversation identifier, or dialog identifier, and an associated timestamp. Thread as used here may refer to one or more rounds of dialog involving the user and an application software system or GAI-based system. An application software system or GAI-based system can manage multiple different threads in parallel within the same system or across multiple different systems. A round of dialog as used herein may refer to a user input and an associated system-generated response, e.g., a reply to the user input that is generated at least in part via a generative artificial intelligence model. For example, a thread can include a first thread portion, such as a question received from a user of a computing device, and a second thread portion, such as natural language text, audio, video, and/or imagery machine-generated by a GAI-based system in response to the user's question.

A thread can have an associated thread identifier. A thread can be made up of non-contiguous thread portions. For instance, a thread can include thread portions that relate to a common topic or application, even if those thread portions are temporally separated from each other by other threads or thread portions. Any dialog, thread, or thread portion can include one or more different types of digital content, including natural language text, audio, video, digital imagery, hyperlinks, and/or multimodal content such as web pages. A thread portion can have an associated source identifier (e.g., user or system) identifying the source of the thread portion, an associated application, and a timestamp.

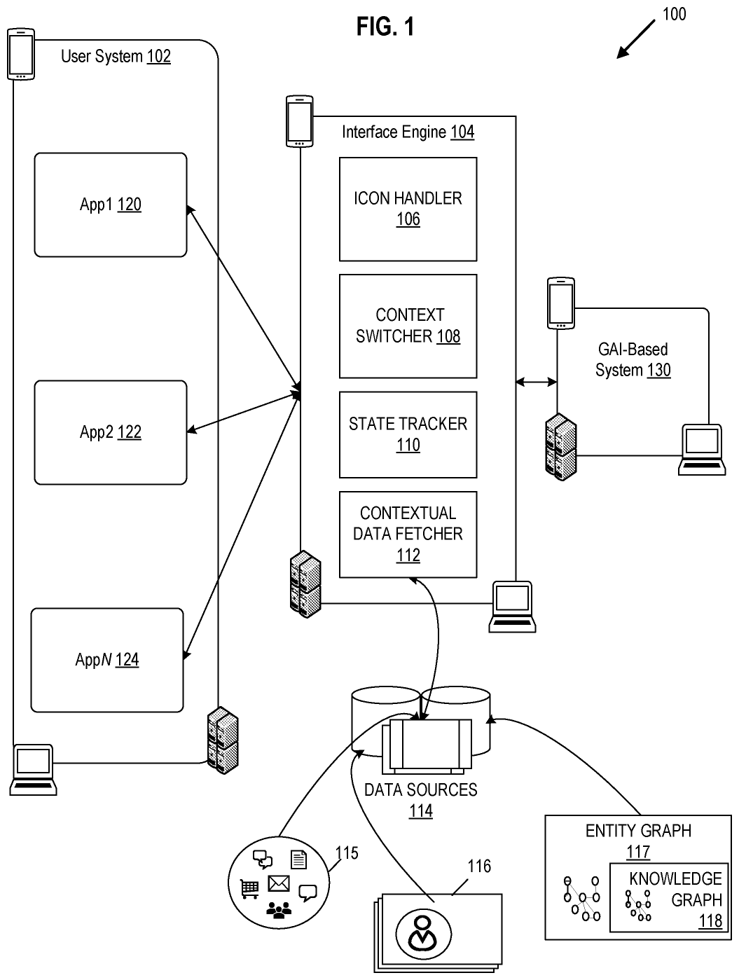

FIG. 1 is a flow diagram of an example method for managing communications among one or more applications and a generative artificial intelligence-based system using components of an interface engine in accordance with some embodiments of the present disclosure.

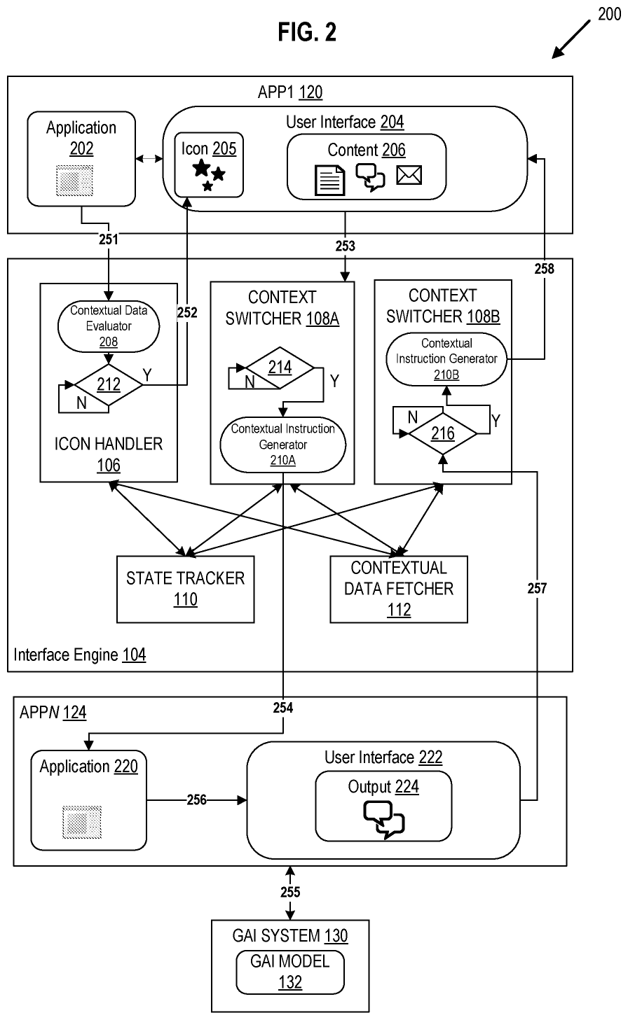

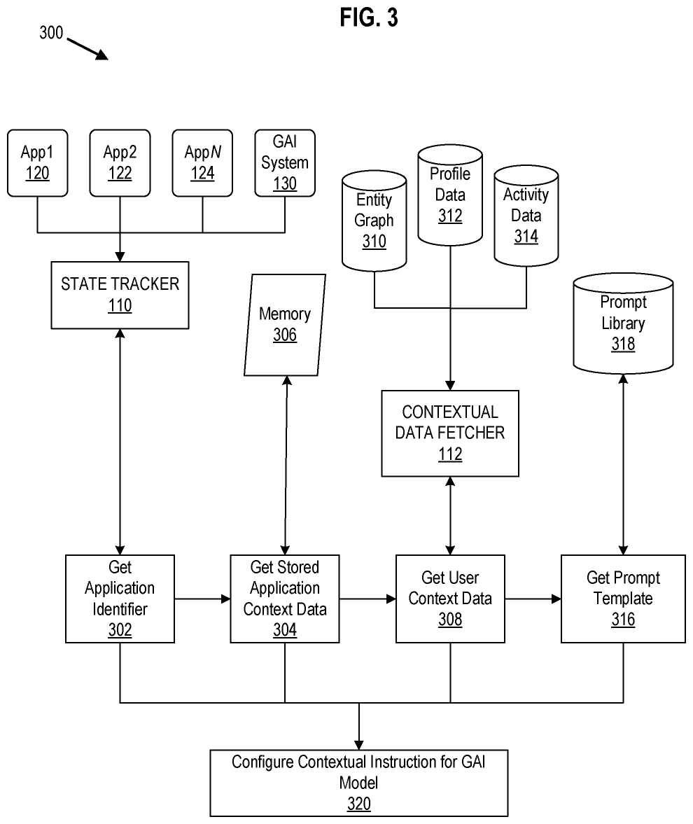

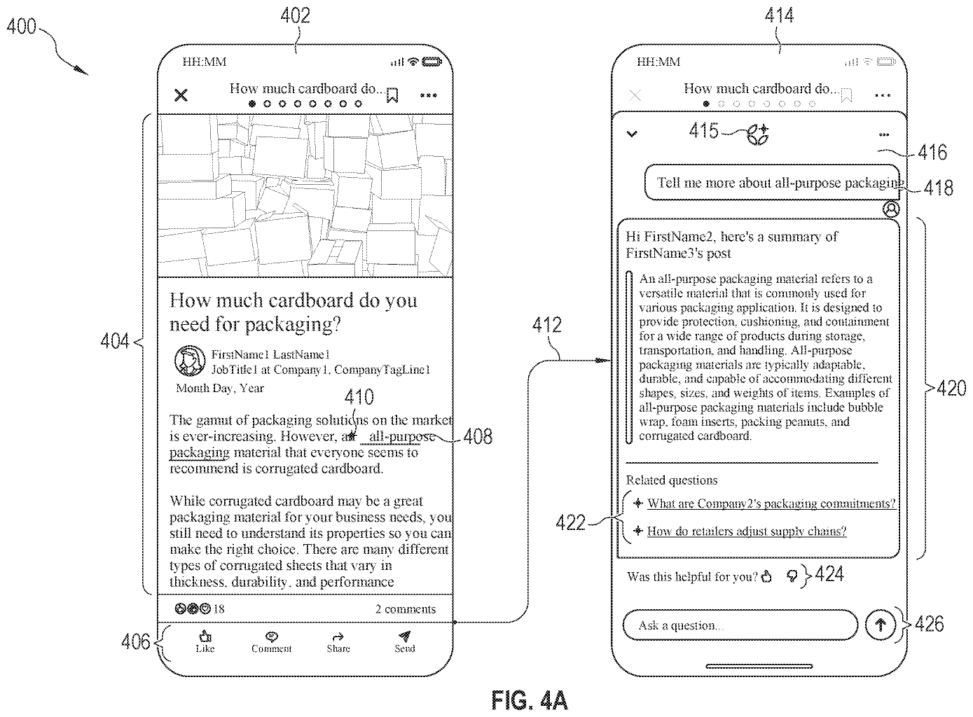

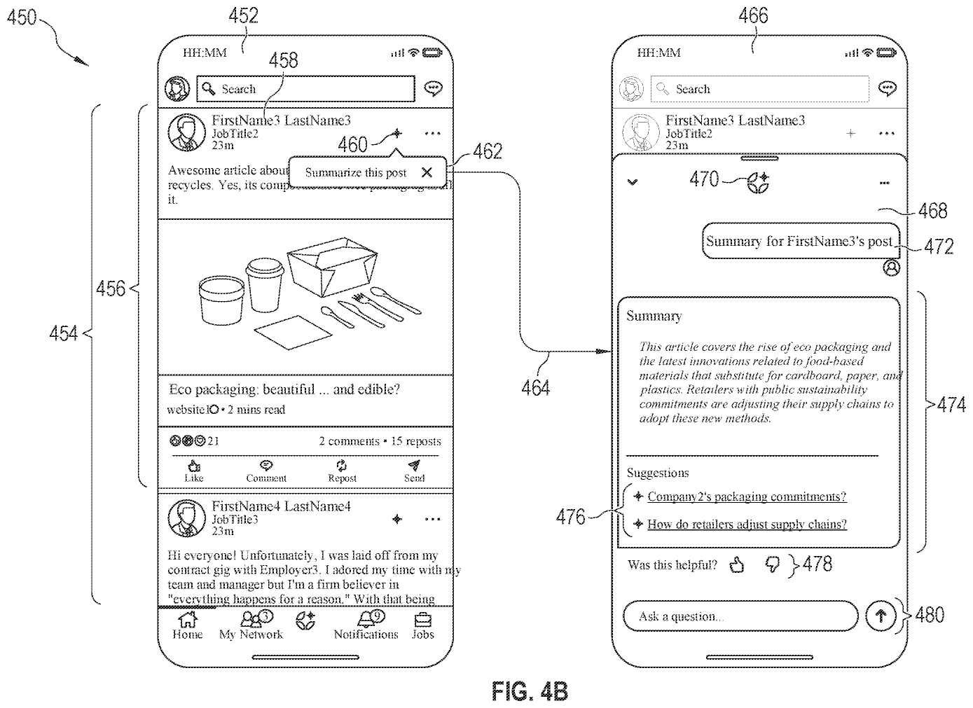

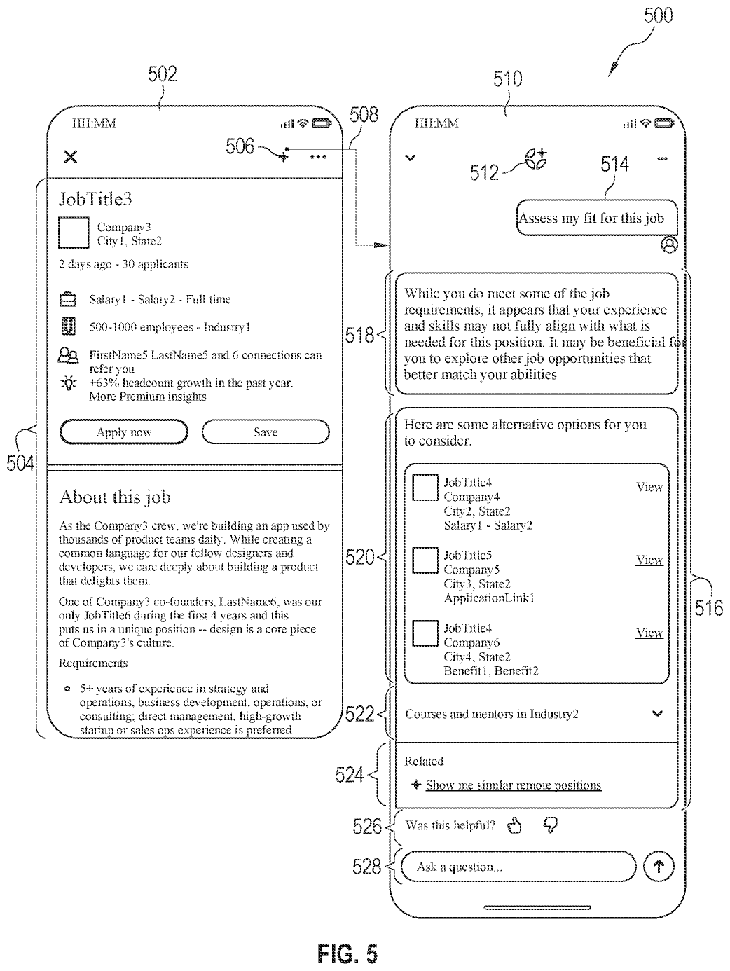

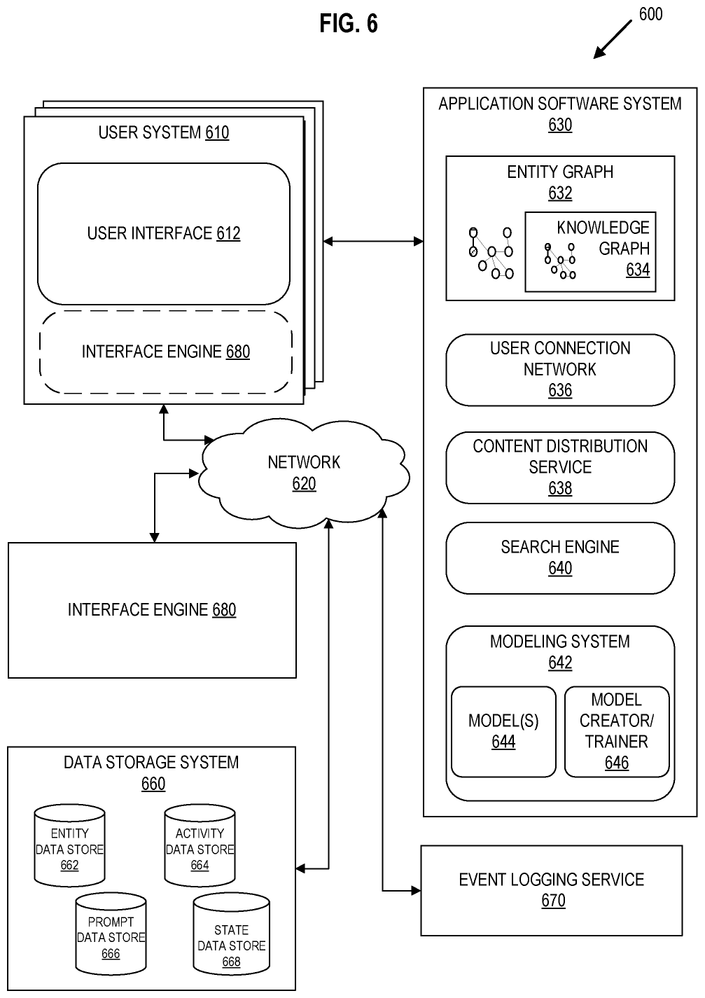

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of interface engine 104, including, in some embodiments, components or flows shown in FIG. 1 that may not be specifically shown in FIG. 6, or by components of interface engine 680 of FIG. 6, including, in some embodiments, components or flows shown in FIG. 6 that may not be specifically shown in FIG. 1, or by components of computing system 200, including, in some embodiments, components or flows shown in FIG. 2 that may not be specifically shown in FIG. 1 or FIG. 6, or by components or flows shown in FIG. 3 that may not be specifically shown in FIG. 1. FIG. 2, or FIG. 6, or by components or flows shown in FIG. 4A, FIG. 4B, or FIG. 5 that may not be specifically shown in FIG. 1, FIG. 2, FIG. 3, or FIG. 6. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In FIG. 1, an example computing system 100 is shown, which includes an example interface engine 104. The interface engine 104 facilitates communications, including communications of instructions and relevant contextual data, between or among one or more application software systems or at least two application software systems. Examples of application software systems include App1 120, App2 122, AppN 124, where there are up to N application software systems and N is a positive integer), portions of which may be running on a user system 102 and/or a server system. Other examples of application software systems include one or more generative artificial intelligence (GAI)-based systems 130.

For purposes of this disclosure, still other examples of application software systems include recommendation systems, such as content item ranking systems, e.g., feed ranking systems and/or job ranking systems. These and other types of application software systems can include or interface with one or more artificial intelligence-based modeling systems, such as machine learning modeling systems, as shown in FIG. 6, described below. In those scenarios, the interface engine 104 can facilitate communications between or among the artificial intelligence modeling systems associated with different application software systems, or between an application software system and a modeling system. For example, interface engine 104 can facilitate the communication of output generated by a generative model of a GAI-based system 130 to a model training system that generates training data used to train a machine learning model, such as a ranking model or scoring model used by a recommendation system.

Certain application software systems (e.g., App1 120, App2 122, AppN 124) include, for example, various different types of content distributions systems or other types of application software systems. For example, App1 120 could be a social network service, App2 122 could be a search engine, and App3 could be a messaging system, media player, or e-commerce application. Any of the application software systems (e.g., App1 120, App2 122, AppN 124) can be, include, or directly access a GAI-based system 130. Alternatively, one or more of the application software systems (e.g., App1 120, App2 122, AppN 124) do not include or directly access GAI technology but instead access to one or more GAI models is made available to one or more of the application software systems App1 120, App2 122, AppN 124 through the GAI-based system 130. For example, in some embodiments, GAI-based system 130 includes a conversational natural language dialog-based user interface (e.g., a chatbot or thread-based messaging system) that includes or is communicatively connected to one or more GAI models.

For instance, the GAI-based system 130 may have access to an application programming interface (API) library for a particular GAI model while other application software systems do not have access to the API library for the GAI model. As another example, one or more of the application software systems App1 120, App2 122, AppN 124 may have access to certain contextual data, such as user context data and/or application context data, while the GAI-based system 130 or associated GAI model does not have direct access to such data. In such cases, a portion of the interface engine 140, such as the contextual data fetcher 112, can run a verification routine to ensure that only data that is permitted to be shared across application boundaries is included in the communications between or among application software systems and GAI-based systems.

In the example of FIG. 1, the components of the interface engine 104 are implemented using an application server or server cluster, which can include a secure environment (e.g., secure enclave, encryption system, etc.) for the processing of data. In other implementations, one or more components of the interface engine 104 are implemented on a client device, such as a user system 102 or a user system 610, described herein with reference to FIG. 6. For example, some or all of interface engine 104 is implemented directly on the user's client device in some implementations, thereby avoiding the need to communicate with servers over a network such as the Internet. In some implementations, the interface engine 104 is in bidirectional communication with one or more user systems 102 via a computer network. The one or more user systems 102 include front end user interface functionality that, in some embodiments, is considered part of or is in communication with interface engine 104.

In the embodiment of FIG. 1, the interface engine 104 includes an icon handler 106, a context switcher 108, a state tracker 110, and a contextual data fetcher 112. Icon handler 106 determines whether or when to enable functionality provided via GAI-based system 130 in connection with a particular application software system (e.g., App1 120, App2 122, AppN 124) or in connection with a particular sub-component of an application software system. For example, icon handler 106 determines whether a sub-component of an application software system currently running in an active window on a user system 102, such as a content item displayed to a user in a news feed, a set of recommendations, or a set of search results, meets one or more threshold criteria for displaying a GAI-invoking icon. An example of a GAI-invoking icon is a graphical user interface (GUI) element or set of GUI elements which, if selected by the user, initiates a switch, including a communication of data, from the currently active application software system to the GAI-based system 130.

Examples of threshold criteria that can be used by icon handler 106 to determine to display the GAI-invoking icon within the currently active application include a threshold length of a content item displayed to the user by the currently active application, and a threshold number of comments and/or other types of reactions (e.g., likes, shares, follows, etc.) associated with the content item. For instance, if a content item displayed in the user's feed contains only a few lines of text or does not have any associated comments or reactions, the threshold criteria may not be met. Conversely, if the content item's string length exceeds a minimum required string length, or the content item's comment count exceeds a minimum required number of comments, the threshold criteria may be met.

If or when the icon handler 106 determines that the threshold criteria for the display of the GAI-invoking icon are met, the GAI-invoking icon is displayed in connection with the sub-component of the application that satisfies the threshold criteria. Examples of GAI-invoking icons are shown in FIG. 4A, FIG. 4B, and FIG. 5, described herein. If or when the icon handler 106 determines that the threshold criteria for the display of the GAI-invoking icon are not met, the GAI-invoking icon is not displayed. The exact threshold criteria used to determine whether or not to display the GAI-invoking icon in connection with a particular application or application sub-component are variable and can be determined based on the requirements of a particular design or implementation of the application or the interface engine.

Context switcher 108 configures contextual instructions for destination applications (e.g., applications into which the user is being switched) based on application context data obtained from source applications (e.g., applications from which context data is obtained and maintained for use by the target applications). Alternatively or in addition, context switcher obtains user context data about the user associated with the application context data and configures contextual instructions for destination applications based on the user context data.

Application context data as used herein may refer to data logged during the user's use of a particular application, such as data input, output, or interacted with, the timestamp at the user's login in to the application, and actions taken by the user during the login session, including implicit and/or explicit user interactions with the application's user interface elements.

User context data as used herein may refer to data logged during the user's use of the most recent source application and/or data logged during the user's use of one or more other applications, such as previous uses of the source application or destination application by the same user.

As an example, when a user is being switched from a source application such as App1 120, App2 122, or AppN 124, into a destination application such as GAI-based system 130, context switcher 108 formulates a specific type of prompt (e.g., a set of one or more instructions configured for input to a GAI model) to include application context data associated with the source application and/or user context data related to the user of the source application, for input to one or more GAI models associated with the destination application. As another example, when a user is being switched from a source application such as GAI-based system 130, into a destination application such as App1 120, App2 122, or AppN 124, context switcher 108 formulates a specific type of prompt (e.g., a set of one or more instructions configured for the destination application) to include application context data associated with the source application (in this case, GAI-based system 130) and/or user context data related to the user of the source application, for input to the destination application.

Prompt as used herein includes, for example, one or more machine-readable questions, statements, instructions, and/or examples in combination with a set of parameter values that constrain the operations of a GAI model in generating and outputting a response to the prompt. For example, a first type of prompt can include instructions to cause a GAI model to generate and output a summary of one or more inputs to the GAI model. As another example, a second type of prompt can include one or more instructions to cause the GAI model to perform a comparison of two sets of inputs related to a particular user (e.g., a comparison of set of user context data to a search result, such as a document or video, e.g., an article, job posting, or learning video). The prompt can also include one or more instructions to, based on the comparison, generate and output a user-personalized assessment of the comparison (e.g., a measurement of the relevance of the search result to the user).

The way in which the elements of the prompt are organized and the phrasing used to articulate the prompt elements can significantly affect the output produced by the GAI model in response to the prompt. For example, a small change in the prompt content or structure can cause the GAI model to generate a very different output. As such, portions of context switcher 108 configure prompts so that the output of one or more GAI models is generated based on, for example, user-specific and application-specific sets of inputs (e.g., current user context data and current application context data associated with a current online user session), by modifying specific parameters, instructions, and constraints based on the current application context and current user context. Additionally or alternatively, portions of context switcher 108 configure prompts so that the output of one or more GAI models is generated based on historical session context and/or activity data associated with the user. For example, the contextual prompt generated by interface engine 104 can have a number of different inputs, including current and/or historical user activity and current and/or historical user engagement data such as information about the user's engagement with various different types of content. As a result, the interface engine 104 can configure prompts based on individual users' specific interests, activity, searches, and/or other online activity. For example, interface engine 104 could configure a prompt to highlight a specific phrase like “eco packaging” to a particular user specifically because that user has read several online posts about that the topic within the past week.

To appropriately configure prompts for GAI models based on the most current application context and user context, portions of interface engine 104 obtain and maintain application context data using state tracker 110. For example, state tracker 110 stores application identifiers and associated timestamp data at each context switch. For instance, prior to or during a switch from a source application to a destination application, state tracker 110 logs the application identifier of the source application, associated state data, and the timestamp of the context switch.

Context switch as used herein may refer to an automated process of storing the state of an application, process or execution thread, so that it can be restored and resume execution at a later point, and then later restoring a different state that was previously saved in a similar manner. The process of context switching involves the storage of the state data related to a given application, process, or execution thread in a way that it can be reloaded when required, such that its execution can be resumed from the same state as was earlier stored.

Portions of interface engine 104 obtain user context data using contextual data fetcher 112. Examples of contextual resources, which can be sources of user context data, shown in FIG. 1, include data sources 114. Data sources 114 include, for example, current and/or historical user activity data 115, user profile data 116, entity graph 117, and knowledge graph 118. User activity data 115 includes, for example, current and/or historical user interaction data logged by event logging service 670 and/or stored in activity data store 664, described below with reference to FIG. 6. User profile data 116 includes, for example, current and/or historical attribute data associated with the user (e.g., user preferences and/or biographical data such as skills, work experiences, and education history) or another entity associated with the user (such as the user's current employer), which may be logged by event logging service 670 and/or stored in entity data store 662, described below with reference to FIG. 6. Entity graph 117 and knowledge graph 118 include, for example, current and/or historical data that describe various relationships between or among different entities in a social graph. For example, entity graph 117 and/or knowledge graph 118 can include one or more portions of entity graph 632 and/or knowledge graph 634, described below with reference to FIG. 6.

In some embodiments, contextual data fetcher 112 includes a verification routine that queries the user's data sharing preferences (which may be stored, for example, as part of user profile data 116) and modifies its data fetching processes to incorporate any pertinent data sharing restrictions. For example, if the user's data sharing preferences indicate that the user does not want activity data 115 logged in connection with the user's use of a specific application to be shared with any other applications, or with specific other applications, then contextual data fetcher 112 will not fetch any activity data 115 to which the data sharing restriction applies.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Contextual data fetcher 112 provides fetched data (restricted as may be applicable due to the user's data sharing preferences) to context switcher 108 for inclusion in one or more contextual instructions such as one or more GAI prompts and/or instructions for non-GAI-based application software systems.

The examples shown in FIG. 1 and the accompanying description, above are provided for illustration purposes. This disclosure is not limited to the described examples. Additional or alternative details and implementations are described herein.

FIG. 2 is a flow diagram of an example method for managing communications among one or more applications and a generative artificial intelligence model using components of an interface engine in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of interface engine 104, including, in some embodiments, components or flows shown in FIG. 2 that may not be specifically shown in FIG. 1 or FIG. 6, or by components of interface engine 680 of FIG. 6, including, in some embodiments, components or flows shown in FIG. 6 that may not be specifically shown in FIG. 2, or by components of computing system 200, including, in some embodiments, components or flows shown in FIG. 2 that may not be specifically shown in FIG. 1 or FIG. 6, or by components or flows shown in FIG. 3 that may not be specifically shown in FIG. 1, FIG. 2, or FIG. 6, or by components or flows shown in FIG. 4A, FIG. 4B, or FIG. 5 that may not be specifically shown in FIG. 1, FIG. 2, FIG. 3, or FIG. 6. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the embodiment of FIG. 2, an application software system App1 120 includes an application 202 and a user interface 204. Application 202 includes the computer program code that when executed by a processor causes the processor to display user interface 204 at a user system (e.g., user system 102 or user system 610). User interface 204 includes a GAI-invoking icon 205 and content 206.

GAI-invoking icon 205 is a graphical user interface control element that, if selected by the user, causes interface engine 104 to initiate a context switch from App1 120 to AppN 124. Content 206 includes one or more digital content items displayed to the user via user interface 204. For example, App1 120 is a content distribution system such as a news feed or search engine, and the content 206 includes one or more different types of content (e.g., text, imagery, video, audio recordings, etc.) displayed to the user via the user interface 204 (e.g., the news feed or search results).

In FIG. 2, interface engine 104 includes embodiments of icon handler 106, context switcher 108A, 108B, state tracker 110, and contextual data fetcher 112. Embodiments of icon handler 106, context switcher 108A, 108B, state tracker 110, and contextual data fetcher 112 include functionality described above for similar components shown in FIG. 1. For example, context switcher 108 of FIG. 1 includes context switcher 108A and context switcher 108B, in some embodiments.

In FIG. 2, icon handler 106 includes a contextual data evaluator 208 and a decision block 212. Contextual data evaluator 208 evaluates the current context of application 202 received by interface engine 104 via communication flow 251 and/or data flows between state tracker 110 and icon handler 106, and/or data flows between contextual data fetcher 112 and icon handler 106. Contextual data evaluator 208 compares the received current context to one or more threshold requirements for displaying icon 205 in the user interface 204. For example, contextual data evaluator 208 obtains information from application 202 that the user is viewing a particular item of content 206, and compares metadata associated with the particular item of content 206 to the one or more threshold requirements for displaying the icon 205. Decision block 212 determines how to respond to the comparison of the current context to the one or more threshold requirements performed by contextual data evaluator 208. If the current context does not satisfy the one or more threshold requirements, decision block 212 takes no action. If the current context satisfies the one or more threshold requirements, decision block 212 initiates a display of icon 205 in the user interface 204 via communication flow 252.

In FIG. 2, context switcher 108A includes a contextual instruction generator 210A and a decision block 214. In response to display of icon 205 at user interface 204 via communication flow 252, decision block 214 of context switcher 108A may from time to time detect a user selection of icon 205 at user interface 204 via communication flow 253. In response to the detection of a user selection of icon 205 via communication flow 253, decision block 214 initiates contextual instruction generator 210A, for example by passing the user selection data associated with the selection of icon 205 to contextual instruction generator 210A. If or when decision block 214 does not detect a user selection of icon 205 at user interface 204, decision block 214 takes no action.

Contextual instruction generator 210A evaluates the current context of application 202 received by interface engine 104 via communication flow 251 and/or communication flow 253, and/or uses data flows between state tracker 110 and context switcher 108A, and/or data flows between contextual data fetcher 112 and context switcher 108A to determine application context data and/or user context data. Contextual instruction generator 210A configures one or more contextual instructions based on the current application context and/or user context. For example, contextual instruction generator 210A determines that the user is viewing an article about a particular topic, selects a prompt template from a prompt library based on the topic, and configures a prompt using the prompt template and relevant portions of retrieved application context data and/or user context data. Contextual instruction generator 210A provides the contextual instruction (e.g., one or more prompts for execution by GAI model 132), configured based on the most recent use of App1 120, e.g., the current application context and/or user context, to AppN 124 via communication flow 254.

In the embodiment of FIG. 2. AppN 124 includes an application 220 and a user interface 222. In an example, both App1 120 and AppN 124 are running on the same user device (e.g., user system 102 or user system 610). Prior to a first context switch, the user interface 204 is the currently active window on the user system. After the first context switch, which is facilitated by interface engine 104 as described herein, the user interface 222 is the currently active window on the user system.

Application 220 includes computer program code that when executed by a processor causes the processor to display user interface 222 at a user system (e.g., user system 102 or user system 610) via one or more communication flows 254, 256. User interface 222 includes output 224. For example, AppN 124 is a messaging system such as a chatbot, and the output 224 includes one or more conversational threads or dialogs that have been machine-generated by GAI model 132 and/or GAI system 130. The output 224 is displayed to the user at the user's device (e.g., user system 102 or user system 610) via the user interface 222 (e.g., the chatbot).

In the embodiment of FIG. 2. AppN 124 is communicatively coupled to GAI system 130. For example, AppN 124 includes one or more API calls to GAI system 130 or GAI model 132, which AppN 124 executes in response to communications from interface engine 104. Alternatively, for example when the computing system 200 or AppN 124 determines that latency has exceeded a latency threshold, AppN 124 can pre-request output 224 generated by GAI model 132 from GAI system 130 and store the pre-generated output 224 for later use when AppN subsequently receives a communication from interface engine 104. In other embodiments, AppN 124 is a GAI system 130 or a GAI model 132 such that the interface engine 104 communicates directly with the GAI system 130 or the GAI model 132 rather than via AppN 124.

In the example of FIG. 2, GAI system 130 includes or is coupled or connected to at least one GAI model 132. GAI model 132 includes one or more neural network-based machine learning models. In some implementations, GAI model 132 is constructed using a neural network-based deep learning model architecture. In some implementations, the neural network-based architecture includes one or more input layers that receive model inputs, generate one or more embeddings based on the model inputs, and pass the one or more embeddings to one or more other layers of the neural network. In other implementations, the one or more embeddings are generated based on the model input by a pre-processor, the embeddings are input to the neural network model, and the neural network model generates output based on the embeddings.

In some implementations, the neural network-based machine learning model architecture includes one or more self-attention layers that allow the model to assign different weights to portions of the model input. Alternatively or in addition, the neural network architecture includes feed-forward layers and residual connections that allow the model to machine-learn complex data patterns including relationships between different portions of the model input in multiple different contexts. In some implementations, the neural network-based machine learning model architecture is constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation of the interface engine 104.

In some examples, the neural network-based machine learning model architecture includes or is based on one or more generative transformer models, one or more generative pre-trained transformer (GPT) models, one or more bidirectional encoder representations from transformers (BERT) models, one or more large language models (LLMs), one or more XLNet models, and/or one or more other natural language processing (NL) models. In some examples, the neural network-based machine learning model architecture includes or is based on one or more predictive text neural models that can receive text input and generate one or more outputs based on processing the text with one or more neural network models. Examples of predictive neural models include, but are not limited to, Generative Pre-Trained Transformers (GPT), BERT, and/or Recurrent Neural Networks (RNNs). In some examples, one or more types of neural network-based machine learning model architectures include or are based on one or more multimodal neural networks capable of outputting different modalities (e.g., text, image, sound, etc.) separately and/or in combination based on textual input. Accordingly, in some examples, a multimodal neural network implemented in the interface engine is capable of outputting digital content that includes a combination of two or more of text, images, video or audio.

In some implementations, GAI model 132 is trained on a large dataset of digital content such as natural language text, images, videos, audio files, or multi-modal data sets. For example, training samples of digital content such as natural language text extracted from publicly available data sources are used to train one or more generative models of a GAI-based system. The size and composition of the datasets used to train one or more models of the interface engine can vary according to the requirements of a particular design or implementation of the GAI-based system. In some implementations, one or more of the datasets used to train one or more models of the interface engine includes hundreds of thousands to millions or more different training samples.

In some embodiments, one or more models of interface engine includes multiple generative models trained on differently sized datasets. For example, an interface engine can include a comprehensive but low capacity generative model that is trained on a large data set and used for generating thread portions in response to user inputs, and the same generative model also can include a less comprehensive but high capacity model that is trained on a smaller data set, where the high capacity model is used to generate outputs based on examples obtained from the low capacity model. In some implementations, reinforcement learning is used to further improve the output of one or more models of a GAI-based system. In reinforcement learning, ground-truth examples of desired model output are paired with respective inputs, and these input-example output pairs are used to train or fine tune one or more models of a GAI-based system.

In some implementations, one or more models of interface engine are implemented using a graph neural network. For example, a modified version of a Bidirectional Encoder Representation with Transformers (BERT) neural network is specifically configured, in one model instance, to generate and output thread classifications, and in another instance, to generate and output machine-generated thread portions. In some implementations, the modified BERT is trained with self-supervision, e.g., by masking some portions of the input data so that the BERT learns to predict the masked data. During scoring, a masked entity is associated with a portion of the input data and the model generates output at the position of the masked entity based on the input data.

In FIG. 2, context switcher 108B includes a contextual instruction generator 210B and a decision block 216. In response to one or more user actions detected at user interface 222 and communicated to interface engine 104 via communication flow 257, decision block 216 of context switcher 108B may from time to time initiate a context switch from AppN 124 back to App1 120 or from AppN 124 to another application, such as App2 122.

In response to communication flow 257, decision block 216 determines whether to initiate contextual instruction generator 210B. For example, if or when decision block 216 determines that the one or more user actions detected at user interface 122 and communicated to interface engine 104 via communication flow 257 does not signal an intent to initiate a context switch, then decision block 216 takes no action. However, if or when decision block 216 determines that the one or more user actions detected at user interface 122 and communicated to interface engine 104 via communication flow 257 does signal an intent to initiate a context switch, then decision block 216 invokes contextual instruction generator 210B. For example, decision block 216 passes user action data associated with the communication flow 257 to contextual instruction generator 210B.

Contextual instruction generator 210B evaluates the current context of application 220 received by interface engine 104 via communication flow 257, and/or uses data flows between state tracker 110 and context switcher 108B, and/or data flows between contextual data fetcher 112 and context switcher 108B, to determine application context data and/or user context data.

Contextual instruction generator 210B configures one or more contextual instructions based on the current application context and/or user context. For example, contextual instruction generator 210B determines that the user engaged in a conversational dialog with a chatbot in user interface 222 about a particular topic, and configures an instruction using relevant portions of retrieved application context data and/or user context data. Contextual instruction generator 210B provides the contextual instruction (e.g., one or more instructions for execution by App1 120, or App2 122, as the case may be), configured based on the current application context and/or user context, to App1 120, or App2 122, as the case may be, via communication flow 258.

In response to the communication flow 258, App1 120, or App2 122, as the case may be, can modify its operations based on the application context data and/or user context data associated with the most recent use of AppN 124, including output of or user interactions with GAI system 130 and/or GAI model 132. For example, App1 120, or App2 122, as the case may be, can update the display of content 206 at user interface 204 based on the application context data and/or user context data associated with the AppN 124, GAI system 130, and/or GAI model 132, received via communication flows 257, 258. For instance, App1 120, or App2 122, as the case may be, can re-rank items in a news feed or set of search results, re-rank a set of notifications, or add or delete content items from the display of content 206 at user interface 204, in response to the application context data and/or user context data associated with the AppN 124, GAI system 130, and/or GAI model 132, received via communication flows 257, 258.

The examples shown in FIG. 2 and the accompanying description, above are provided for illustration purposes. This disclosure is not limited to the described examples. Additional or alternative details and implementations are described herein.

FIG. 3 is a flow diagram of an example method for configuring one or more contextual instructions to be included in a prompt for a generative artificial intelligence model using components of an interface engine in accordance with some embodiments of the present disclosure.

The method 300 is performed in response to a trigger. An example of a trigger is the user selecting an icon or taking some other action via the user interface that causes a context switch from a first application to a second application, where at least one of the first application or the second application presents output generated by a GAI model based on contextual data obtained from the other application (for example, the first application presents output generated by a GAI model based on contextual data obtained from the second application, or the second application presents output generated by a GAI model based on contextual data obtained from the first application). For case of discussion, the application from which contextual data is obtained for use by the GAI model may be referred to as the source application and the application that presents output generated by the GAI model based on the contextual data obtained from the source application may be referred to as the destination application.

Get application identifier component 302 obtains application identifier data via state tracker 110. Get application identifier component 302 determines which application is the first (or source) application for purposes of the current context switch. For example, get application identifier component 302 obtains, from state tracker 110, information that identifies the most recently active window in the user's graphical user interface (e.g., user interface 612 of FIG. 6, described herein), and obtains identifying information, such as a unique identifier, for the application associated with the most recently active window. The application associated with the most recently active window could be, for example, App1 120, App2 122, AppN 124, or GAI system 130.

Get application identifier component 302 provides the identifying information obtained from state tracker 110 to one or more of get stored application context data component 304 or configure contextual instruction for GAI model component 320. For ease of discussion, the identifying information for the first or source application (e.g., the application associated with the most recently active window) may be referred to herein as the first application identifier or source application identifier.

Using the first (or source) application identifier provided by get application identifier component 302, get stored application context data component 304 searches memory 306 for application context data associated with the first (or source) application identifier. For example, memory 306 may be a cache or other form of volatile memory that stores application context data as a value associated with a key of the first (or source) application identifier, such that get stored application context data component 304 searches for a key that has an associated value that matches the first (or source) application identifier.

If or when get stored application context data component 304 determines that memory 306 contains application context data associated with the first (or source) application identifier, get stored application context data component 304 retrieves the application context data associated with the first (or source) application identifier and provides the application context data associated with the first (or source) application identifier to one or more of get user context data component 308 or configure contextual instruction for GAI model component 320. For case of discussion, the application context data associated with the first application identifier (e.g., the application context data associated with the most recently active window) may be referred to herein as the first application context data.

Examples of application context data include interactions logged by, e.g., event logging service 670 shown in FIG. 6, described herein). For instance, application context data can include user selections, views, and/or reactions to content, comments entered by the user about content, and/or navigational actions taken by the user, such as scrolling past content items, opening or ignoring notifications, or selections of graphical user interface control elements or icons by the user. In some examples, application context data may refer to the most recent action or sequence of actions performed by the user in the first application prior to the initiation of the context switch; for example, the last content item viewed by the user before the context switch.

Get user context data component 308 uses one or more of the first (or source) application identifier obtained via get application identifier component 302 or the first (or source) application context data obtained via get stored application context data component 304 to obtain user context data via contextual data fetcher 112. For example, get user context data component 308 passes or provides the application identifier and/or application context data to contextual data fetcher 112.

Contextual data fetcher 112 uses the application identifier and/or application context data obtained from get user context data component 308 to obtain user context data via one or more of entity graph 310, profile data 312, or activity data 314. For example, contextual data fetcher 112 searches or traverses entity graph 310, profile data 312, and/or activity data 314 and retrieves user context data that matches the application identifier and/or application context data provided by get user context data component 308. Contextual data fetcher 112 provides the retrieved user context data to one or more of get prompt template component 316 or configure contextual instruction for GAI model component 320.

Entity graph 310 includes, for example, entity graph 632 and/or knowledge graph 634 shown in FIG. 6, described herein. Profile data 312 includes, for example, data stored in entity data store 662, shown in FIG. 6, described herein. Activity data 314 includes, for example, data stored in activity data store 664, shown in FIG. 6, described herein. Illustrative, non-limiting examples of activity data 314 include the examples described herein with reference to FIG. 6 and, alternatively or in addition, include the user's historical online activity (e.g., interactions with content, user profiles viewed, engaged content, content created by the user, etc.). For example, portions of activity data 314 can be stored in a database and then retrieved by the contextual data fetcher 112 to generate contextual instructions for a GAI model.

An example of user context data is user profile data, such as skills or work experience, that is relevant to a job posting displayed by the first (or source) application. Another example of user context data is user connection data, such as whether the user and the author of a post viewed by the user in the first (or source) application have any common connections in a user network such as user connection network 636, shown in FIG. 6, described herein.

Still another example of user context data is information about the user's prior search history using a search engine (e.g., search engine 640 of FIG. 6, described herein), such as previous job searches conducted by the user in the first (or source) application. Yet another example of user context data is information about the user's history of activity relating to one or more feeds provided by a content distribution service of the first (or source) application (e.g., content distribution service 638 of FIG. 6, described herein), such as topics or titles of articles that the user clicked on, viewed, reacted to, or commented on.

Get prompt template component 316 uses one or more of the first (or source) application identifier obtained via get application identifier component 302 or the first (or source) application context data obtained via get stored application context data component 304 or the user context data obtained via get user context data component 308 to select or generate a prompt for a GAI model. For example, get prompt template component 316 searches a prompt library 318 and retrieves a prompt that matches one or more of the first (or source) application identifier obtained via get application identifier component 302 or the first (or source) application context data obtained via get stored application context data component 304 or the user context data obtained via get user context data component 308.

As an example, prompt library 318 can include prompt templates that are configured for various different application contexts. For instance, prompt library 318 can include a first prompt template that is configured to instruct a GAI model to summarize a piece of content and a second prompt template that is configured to instruct a GAI model to machine-generate a comparison of the user context data to a piece of content, such as a user-personalized job assessment of how well the user's qualifications match the requirements of a job posting. Any prompt template can include one or more instructions and one or more placeholders into which portions of application context data and/or user context data can be inserted. Get prompt template component 316 selects or generates a prompt template using prompt library 318 and provides the selected or generated prompt template to configure contextual instruction for GAI model component 320.

Configure contextual instruction for GAI model component 320 uses one or more of the first (or source) application identifier obtained via get application identifier component 302 or the first (or source) application context data obtained via get stored application context data component 304 or the user context data obtained via get user context data component 308 to configure the prompt template obtained via get prompt template component 316. For example, configure contextual instruction for GAI model component 320 inserts selected portions of the application context data and/or user context data into one or more placeholders of the selected or generated prompt template. Configure contextual instruction for GAI model component 320 formulates a prompt based on the selected portions of the application context data and/or user context and the selected or generated prompt template, and outputs the resulting prompt to a GAI model, such as a GAI model 132 of a GAI system 130, shown in FIG. 1 and FIG. 2, described herein.

In some implementations, the configure contextual instruction for GAI model component 320 includes rewriting a prompt in order to simplify the downstream job for the GAI language model. In some implementations, the configure contextual instruction for GAI model component 320 configures the prompt to include instructions for the GAI model to perform specific steps of the prompt online or offline, e.g., to conserve or optimize the use of computing resources.

A flow similar to FIG. 3 with similar components but excluding the get prompt template component 316 and prompt library 318 can be used if the destination application does not invoke a GAI model. In that case, configure contextual instruction for GAI model component 320 contains a component that omits the operations pertaining to formulation of a GAI prompt and instead formulates the one or more instructions according to the requirements of the particular destination application.

The examples shown in FIG. 3 and the accompanying description, above are provided for illustration purposes. This disclosure is not limited to the described examples. Additional or alternative details and implementations are described herein.

FIG. 4A illustrates an example of at least one flow 400 including screen captures of user interface screens configured to facilitate communications between or among one or more applications and a generative artificial intelligence model using components of an interface engine in accordance with some embodiments of the present disclosure.

In the user interfaces shown in FIG. 4A, certain data that would normally be displayed may be anonymized for the purpose of this disclosure. In a live example, the actual data and not the anonymized version would be displayed. For instance, the text “JobTitle” would be replaced with an actual job title (e.g., software engineer) and “FirstName LastName” would be replaced with a user's actual name.

The user interfaces shown in FIG. 4A are presented to a user by different application software systems, such as app1 120, app2 122, or appN 124. In some implementations, the user interfaces are each implemented as a web page that is stored, e.g., at a server or in a cache of a user device, and then loaded into a display of a user device via the user device sending a page load request to the server or fetching data from the cache. The icons and the selection and arrangement of elements shown in the user interfaces are copyright 2023 LinkedIn Corporation, all rights reserved.

The graphical user interface control elements (e.g., fields, boxes, buttons, etc.) shown in the screen captures are implemented via software used to construct the user interface screens. While the screen captures illustrate examples of user interface screens, e.g., visual displays, this disclosure is not limited to the illustrated embodiments, or to visual displays, or to graphical user interfaces.

In FIG. 4A, a user interface 402 is a display screen generated and presented by a first application and user interface 416 is a display screen generated and presented by a second software application. For instance, user interface 402 displays a content item 404 and a set of control elements 406. The content item 404 is included, for example, in a feed or a set of search results. On the other side of FIG. 4A, user interface 416 displays a chatbot-style user interface in which interactions between the user and the second software application are configured using a conversational dialog format.

In user interface 402, the content item 404 includes a combination of text, imagery, embedded graphical user interface (GUI) control elements, and embedded contextual data. Embedded GUI control element 410 is positioned within the content item 404 at a screen location that indicates to the user that the highlighted topic 408 can be explored further using the second application user interface 416.

In some implementations, an interface engine, such as interface engine 104 or interface engine 680, determines that the control element 410 is to be displayed in association with the topic 408 based on satisfaction of one or more threshold criteria. For example, the interface engine can determine the content item 404 has a minimum length, or that the content item has a minimum number of associated comments, or that the content item 404 has a minimum number of sentences, paragraphs, or comments that pertain to the topic 408. When the interface engine determines that the one or more threshold criteria has been met, the control element 410 is displayed adjacent to the topic 408, and a form of highlighting (e.g., change in color) is applied to the topic 408. If the interface engine determines that the one or more threshold criteria has not been met, the control element 410 is not displayed adjacent to the topic.

If the user selects the control element 410, the interface engine logs the current state of the first application, stores at least the topic 408 in a memory that is accessible to both the first application and the second application, and causes the application context to switch from the first application to the second application as indicated by the context switch arrow 412.

After the context switch, the user interface 416 of the second application at least partially overlays a background version 414 of the user interface 402. The user interface 416 includes an icon 415, which corresponds to the control element 410, and a chat-style natural language dialog including a user-initiated dialog input 418 and a system-generated dialog output 420. The user-initiated dialog input 418 includes input submitted by the user in the chatbot-style interface of the second application after the context switch. Alternatively, rather than requiring the user to enter the input 418, the interface engine can retrieve the topic 408 from the memory and auto-generate the input 418 based on the topic 408, so the user then just needs to review and revise or accept the input 418. As discussed herein, the interface engine can incorporate current and/or historical user-specific context data into the generation of the input 418, in some embodiments. For example, the interface engine could generate input 418 that includes one or more options such as: “teach me about the business of all-purpose packaging” or “tell me about prominent individuals in the packaging industry,” or “tell me about companies prominent in all-purpose packaging.”

In response to the input 418 and the topic 408, and potentially based on one or more other current and/or historical user-specific context data, the interface engine configures a prompt for a generative artificial intelligence (GAI) model including the input 418 and the topic 408 from the first application, and potentially includes one or more items of current and/or historical user-specific context data in the prompt. In the example of FIG. 4A, the interface engine configures a prompt that includes an instruction to summarize a post that talks about the topic 408 obtained from the first application. In this example, the topic 408 is obtained based on, for example, user-specific context data generated by the first application that indicates that the user interacted with a content item related to that topic in the first application. The interface engine sends the prompt (which has been configured based on user-specific information obtained from the first application) to the GAI model. The GAI model generates and outputs the system-generated dialog output 420. The system-generated dialog output 420 includes a text summary pertaining to the topic 408 (and/or other user-specific context data) and links 422 to additional information relating to the topic 408. Thus, as shown in FIG. 4A, the system-generated dialog output 420 can include multiple different forms or modes of output, including text and related links. To generate multimodal output, the interface engine can configure the prompt to include multiple instructions, such as an instruction to summarize text or contextual data and an instruction to search for links related to the summarized text.

The user interface 416 of the second application also includes a feedback mechanism 424 and a search input mechanism 426. The feedback mechanism 424 enables the second application to receive user input that can be used to tune the GAI model or to configure a subsequent prompt. The search input mechanism 426 enables the second application to continue the dialog with the user if, for example, the user would like to explore the topic 408 in more detail or ask a different question. As such, the dialog between the user and the second application can continue for multiple rounds in the second application while the state of the first application is retained in memory.

The interface engine also logs user activity in the second application and stores the activity data in a memory that is accessible to both the second application and the first application, and potentially also is accessible to other applications. The memory in which the activity data is stored may be the same as the memory used to store the topic 408 or a different memory. As a result, if or when the user wants to return to the first application, the interface engine provides the user activity data from the second application to the first application. For example, the user activity data from the second application can include user interactions with certain portions of the output of the GAI model. The information about these interactions can be used by the first application to, after a context switch back to the first application, re-rank the user's feed, re-rank the user's search results, or otherwise reconfigure or reorder the display of content presented to the user in the first application. In this way, the interface engine provides seamless transitions and transfers of contextual data (e.g., topic 408) from the first application to the second application, and also provides seamless transitions and transfers of contextual data (e.g., user interactions with output of the GAI model) from the second application to the first application.

While not specifically shown in FIG. 4A, an online dialog such as the one shown in FIG. 4A can be used to initiate a dialog with another application, such as a third application that provides different functionality than the first application and the second application. Additionally or alternatively, user-specific contextual information obtained about the user by the interface engine from, e.g., the first application or the second application, such as current and/or historical user interactions within the first application or the second application, can be used to, for example, train or tune one or more models used by one or more recommendation systems that support, e.g., a third application. For example, user-specific contextual information obtained by the interface engine from the first application or the second application can be provided by the interface engine to a model training system to train or tune a machine learning model, in order to improve content recommendations and/or other types of recommendations (including suggested inputs such as the suggested input 418), where the suggested input output by the recommendation system and presented to the user is based on the context obtained by the interface engine from the first application and/or the second application.

The examples shown in FIG. 4A and the accompanying description are provided for illustration purposes. For example, while the examples are illustrated as user interface screens for a smaller form factor such as smart phones, tablet computers, or wearable devices, the user interfaces can be configured for other forms of electronic devices, such as desktop computers and/or laptop devices. This disclosure is not limited to the described examples. Additional or alternative details and implementations are described herein.

FIG. 4B illustrates an example of at least one flow 450 including screen captures of user interface screens configured to facilitate communications between or among one or more applications and a generative artificial intelligence model using components of an interface engine in accordance with some embodiments of the present disclosure.

In the user interfaces shown in FIG. 4B, certain data that would normally be displayed may be anonymized for the purpose of this disclosure. In a live example, the actual data and not the anonymized version would be displayed. For instance, the text “JobTitle” would be replaced with an actual job title (e.g., software engineer) and “FirstName LastName” would be replaced with a user's actual name.

The user interfaces shown in FIG. 4B are presented to a user by different application software systems, such as app1 120, app2 122, or appN 124. In some implementations, the user interfaces are each implemented as a web page that is stored, e.g., at a server or in a cache of a user device, and then loaded into a display of a user device via the user device sending a page load request to the server or fetching data from the cache. The icons and the selection and arrangement of elements shown in the user interfaces are copyright 2023 LinkedIn Corporation, all rights reserved.

The graphical user interface control elements (e.g., fields, boxes, buttons, etc.) shown in the screen captures are implemented via software used to construct the user interface screens. While the screen captures illustrate examples of user interface screens, e.g., visual displays, this disclosure is not limited to the illustrated embodiments, or to visual displays, or to graphical user interfaces.

In FIG. 4B, a user interface 452 is a display screen generated and presented by a first application and user interface 468 is a display screen generated and presented by a second software application. For instance, user interface 452 displays a feed 454 including a content item 456 and a control element 460. On the other side of FIG. 4B, user interface 468 displays a chatbot-style user interface in which interactions between the user and the second software application are configured using a conversational dialog format.

In user interface 452, the content item 456 is included in a post 458. The content item 456 includes a combination of text, imagery, graphical user interface (GUI) control elements, and contextual data. A GUI control element 460 is positioned within the post 458 at a screen location that indicates to the user that additional functionality is available with respect to the post 458. In the example of FIG. 4B, the control element 460 is specifically associated with the post 458 and not with the feed 454 or the user interface 452 more generally.

In some implementations, an interface engine, such as interface engine 104 or interface engine 680, determines that the control element 460 is to be displayed in association with the post 458 based on satisfaction of one or more threshold criteria. For example, the interface engine can determine the content item 456 has a minimum length, or that the post 458 has a minimum number of associated comments, or that the content item 456 has a minimum number of sentences, paragraphs, or comments that pertain to a particular topic that the first application has determined may be of interest to the user based on the user's profile and/or previous activity. When the interface engine determines that the one or more threshold criteria has been met, the control element 460 is displayed as part of the post 458. If the interface engine determines that the one or more threshold criteria has not been met, the control element 460 is not displayed as part of the post 458.

If the user selects or hovers over the control element 460, the interface engine displays a notification including text 462 that informs the user of the type of action that is available. In the example of FIG. 4B, the available action is to summarize the post 458. In other examples, the interface engine makes a different type of action available based on the application context alone or in combination with current and/or historical user-specific context data. For example, if the user had previously indicated interest in a specific topic or their previous interaction history indicates an affinity for a specific type of content, a particular type action relevant to the application and/or user context data could be made available by the interface engine.

The interface engine logs the current state of the first application, stores information about the user's activity in the first application (e.g., the text 462, identifying information for the post 458, and/or metadata associated with the post 458) in a memory that is accessible to both the first application and the second application, and causes the application context to switch from the first application to the second application as indicated by the context switch arrow 464.

After the context switch, the user interface 468 of the second application at least partially overlays a background version 466 of the user interface 452. The user interface 468 includes an icon 470, which corresponds to the control element 460, and a chat-style natural language dialog including a user-initiated dialog input 472 and a system-generated dialog output 474. The user-initiated dialog input 472 includes input submitted by the user in the chatbot-style interface of the second application after the context switch. Alternatively, rather than requiring the user to enter the input 472, the interface engine can retrieve the text 462 from the memory and auto-generate the input 472 based on the text 462, so the user then just needs to review and revise or accept the input 472.

In response to the input 472 and the text 462 and associated contextual data from the first application, the interface engine configures a prompt for a generative artificial intelligence (GAI) model including the input 472, the text 462, and the associated contextual data from the first application. In the example of FIG. 4B, the interface engine configures a prompt that includes an instruction to summarize the post 458, with identifying information for the post 458 from the first application. The interface engine sends the prompt to the GAI model. The GAI model generates and outputs the system-generated dialog output 474. The system-generated dialog output 474 includes a text summary of the post 458 and links 476 to additional information relating to the post 458. Thus, as shown in FIG. 4B, the system-generated dialog output 474 can include multiple different forms or modes of output, including text and related links. To generate multimodal output, the interface engine can configure the prompt to include multiple instructions, such as an instruction to summarize text and an instruction to search for links related to the summarized text.

The user interface 468 of the second application also includes a feedback mechanism 478 and a search input mechanism 480. The feedback mechanism 478 enables the second application to receive user input that can be used to tune the GAI model or to configure a subsequent prompt. The search input mechanism 480 enables the second application to continue the dialog with the user if, for example, the user would like more information related to the post 458 or ask a different question. As such, the dialog between the user and the second application about the post 458 in the first application can continue for multiple rounds in the second application while the state of the first application is retained in memory.

The interface engine also logs the user's activity in the second application and stores the activity data in a memory that is accessible to both the second application and the first application, which may be the same as the memory used to store the text 462 and related context data or a different memory. As a result, if or when the user wants to return to the first application, the interface engine provides the user activity data from the second application to the first application. For example, the user activity data from the second application can include user interactions with certain portions of the output of the GAI model. The information about these interactions can be used by the first application to, after a context switch back to the first application, re-rank the user's feed, re-rank the user's search results, or otherwise reconfigure or reorder the display of content presented to the user in the first application. In this way, the interface engine provides seamless transitions and transfers of contextual data (e.g., text 462 and related context data) from the first application to the second application, and also provides seamless transitions and transfers of contextual data (e.g., user interactions with output of the GAI model) from the second application to the first application.

The examples shown in FIG. 4B and the accompanying description are provided for illustration purposes. For example, while the examples are illustrated as user interface screens for a smaller form factor such as smart phones, tablet computers, or wearable devices, the user interfaces can be configured for other forms of electronic devices, such as desktop computers and/or laptop devices. This disclosure is not limited to the described examples. Additional or alternative details and implementations are described herein.

FIG. 5 illustrates an example of at least one flow 500 including screen captures of user interface screens configured to facilitate communications between or among one or more applications and a generative artificial intelligence model using components of an interface engine in accordance with some embodiments of the present disclosure.

In the user interfaces shown in FIG. 5, certain data that would normally be displayed may be anonymized for the purpose of this disclosure. In a live example, the actual data and not the anonymized version would be displayed. For instance, the text “JobTitle” would be replaced with an actual job title (e.g., software engineer) and “FirstName LastName” would be replaced with a user's actual name.

The user interfaces shown in FIG. 5 are presented to a user by different application software systems, such as app1 120, app2 122, or appN 124. In some implementations, the user interfaces are each implemented as a web page that is stored, e.g., at a server or in a cache of a user device, and then loaded into a display of a user device via the user device sending a page load request to the server or fetching data from the cache. The icons and the selection and arrangement of elements shown in the user interfaces are copyright 2023 LinkedIn Corporation, all rights reserved.

The graphical user interface control elements (e.g., fields, boxes, buttons, etc.) shown in the screen captures are implemented via software used to construct the user interface screens. While the screen captures illustrate examples of user interface screens, e.g., visual displays, this disclosure is not limited to the illustrated embodiments, or to visual displays, or to graphical user interfaces.

In FIG. 5, a user interface 502 is a display screen generated and presented by a first application and user interface 510 is a display screen generated and presented by a second software application. For instance, user interface 502 displays a job posting 504 including multiple forms or modes of content and a control element 506. On the other side of FIG. 5, user interface 510 displays a chatbot-style user interface in which interactions between the user and the second software application are configured using a conversational dialog format.

In user interface 502, the job posting 504 includes a combination of text, graphics, and graphical user interface (GUI) control elements. The GUI control element 506 is positioned within the job posting 504 at a screen location that indicates to the user that additional functionality is available with respect to the job posting 504. In the example of FIG. 5, the control element 506 is specifically associated with the job posting and not with the user interface 502 more generally.

In some implementations, an interface engine, such as interface engine 104 or interface engine 680, determines that the control element 506 is to be displayed in association with the job posting 504 based on satisfaction of one or more threshold criteria. For example, the interface engine can determine that the job posting 504 has a minimum length, or that the job posting 504 has a minimum number of associated attribute values that match attribute values of the user profile, or that the job posting 504 matches one or more relevance criteria with respect to a job search entered by the user in the first application. When the interface engine determines that the one or more threshold criteria has been met, the control element 506 is displayed as part of the job posting 504. If the interface engine determines that the one or more threshold criteria has not been met, the control element 506 is not displayed as part of the job posting 504.

If the user selects or hovers over the control element 506, the interface engine interface engine logs the current state of the first application, including the first application context (e.g., job posting rather than feed item), stores information about the user's activity in the first application (e.g., information about the relevance of the job posting 504 to the user's job search criteria, identifying information for the job posting 504, and/or metadata associated with the job posting 504) in a memory that is accessible to both the first application and the second application, and causes the application context to switch from the first application to the second application as indicated by the context switch arrow 508.

After the context switch, the user interface 510 of the second application at least partially overlays the user interface 502 on the user's device. The user interface 510 includes an icon 512, which corresponds to the control element 506 in the first application, and a chat-style natural language dialog including a user-initiated dialog input 514 and a system-generated dialog output 516. The user-initiated dialog input 514 includes input submitted by the user in the chatbot-style interface of the second application after the context switch. Alternatively, rather than requiring the user to enter the input 514, the interface engine can generate the input 514 based on data retrieved from the memory (e.g., information about the current state of the first application, such as the relevance of the job posting 504 to the user's job search criteria) and auto-generate the input 514 based on the data retrieved from the memory, so the user then just needs to review and revise or accept the input 514.

In response to the input 514 and the associated contextual data from the first application, the interface engine configures a prompt for a generative artificial intelligence (GAI) model including the input 514 and the associated contextual data from the first application. In the example of FIG. 5, the interface engine configures a prompt that includes an instruction to summarize the job posting 504, with identifying information for the job posting 504 obtained from the first application. The interface engine sends the prompt to the GAI model. The GAI model generates and outputs the system-generated dialog output 516. The system-generated dialog output 516 includes a text summary 518 of the job posting 504, links to alternative job postings 520, links 522 to related resources such as courses and mentors in topics related to the job posting, and links 524 to additional job postings relating to the job posting 504. Thus, as shown in FIG. 5, the system-generated dialog output 516 can include multiple different forms or modes of output, including text and related links. To generate multimodal output, the interface engine can configure the prompt to include multiple instructions, such as an instruction to summarize text and an instruction to search for job postings or links related to the summarized text.

The user interface 510 of the second application also includes a feedback mechanism 526 and a search input mechanism 528. The feedback mechanism 526 enables the second application to receive user input that can be used to tune the GAI model or to configure a subsequent prompt. The search input mechanism 528 enables the second application to continue the dialog with the user if, for example, the user would like more information related to the job posting 504 or to ask a different question. As such, the dialog between the user and the second application about the job posting 504 in the first application can continue for multiple rounds in the second application while the state of the first application is retained in memory.

The interface engine also logs the user's activity in the second application and stores the activity data in a memory that is accessible to both the second application and the first application, which may be the same as the memory used to store the first application context data relating to the job posting or a different memory. As a result, if or when the user wants to return to the first application, the interface engine provides the user activity data from the second application to the first application. For example, the user activity data from the second application can include user interactions with certain portions of the output of the GAI model. The information about these interactions can be used by the first application to, after a context switch back to the first application, recommend a different job search, re-rank the user's search results, or otherwise reconfigure or reorder the display of content presented to the user in the first application. In this way, the interface engine provides seamless transitions and transfers of contextual data (e.g., job posting context data) from the first application to the second application, and also provides seamless transitions and transfers of contextual data (e.g., user interactions with output of the GAI model) from the second application to the first application.

The examples shown in FIG. 5 and the accompanying description are provided for illustration purposes. For example, while the examples are illustrated as user interface screens for a smaller form factor such as smart phones, tablet computers, or wearable devices, the user interfaces can be configured for other forms of electronic devices, such as desktop computers and/or laptop devices. This disclosure is not limited to the described examples. Additional or alternative details and implementations are described herein.

FIG. 6 is a block diagram of a computing system that includes an interface engine in accordance with some embodiments of the present disclosure.

In the embodiment of FIG. 6, a computing system 600 includes one or more user systems 610, a network 620, an application software system 630, an interface engine 680, a data storage system 660, and an event logging service 670.

All or at least some components of interface engine 680 are implemented at the user system 610, in some implementations. For example, portions of interface engine 680 are implemented directly upon a single client device such that communications involving applications running on user system 610 and interface engine 680 occur on-device without the need to communicate with, e.g., one or more servers, over the Internet. Dashed lines are used in FIG. 6 to indicate that all or portions of interface engine 680 can be implemented directly on the user system 610, e.g., the user's client device. In other words, both user system 610 and interface engine 680 can be implemented on the same computing device, in some implementations. In other implementations, all or portions of interface engine 680 are implemented on one or more servers and in communication with user systems 610 via network 620. Components of the computing system 600 including the interface engine 680 are described in more detail herein.

A user system 610 includes at least one computing device, such as a personal computing device, a server, a mobile computing device, a wearable electronic device, or a smart appliance, and at least one software application that the at least one computing device is capable of executing, such as an operating system or a front end of an online system. Many different user systems 610 can be connected to network 620 at the same time or at different times. Different user systems 610 can contain similar components as described in connection with the illustrated user system 610. For example, many different end users of computing system 600 can be interacting with many different instances of application software system 630 through their respective user systems 610, at the same time or at different times.

User system 610 includes a user interface 612. User interface 612 is installed on or accessible to user system 610 via network 620. Embodiments of user interface 612 include a front end portion of interface engine 680.

User interface 612 includes, for example, a graphical display screen that includes graphical user interface elements such as at least one input box or other input mechanism and at least one slot. A slot as used herein refers to a space on a graphical display such as a web page or mobile device screen, into which digital content such as feed items, chat boxes, or threads, can be loaded for display to the user. For example, user interface 612 may be configured with a scrollable arrangement of variable-length slots that simulates an online chat or instant messaging session. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, a slot may be defined using a three-dimensional coordinate system. Example screen captures of user interface screens that can be included in user interface 612 are shown in the drawings and described herein.

User interface 612 can be used to interact with one or more application software systems 630 and/or to switch between applications such as app1 120, app2 122, appN 124, and/or GAI system 130. For example, user interface 612 enables the user of a user system 610 to create, edit, send, view, receive, process, and organize content items, news feeds, and/or portions of online dialogs. In some implementations, user interface 612 enables the user to upload, download, receive, send, or share various different types of digital content items, including posts, articles, comments, and shares, to initiate user interface events, and to view or otherwise perceive output such as data and/or digital content produced by an application software system 630, interface engine 680, content distribution service 638 and/or search engine 640. For example, user interface 612 can include a graphical user interface (GUI), a conversational voice/speech interface, a virtual reality, augmented reality, or mixed reality interface, and/or a haptic interface. User interface 612 includes a mechanism for logging in to a variety of different application software systems 630, clicking or tapping on GUI user input control elements, and interacting with digital content items such as posts, articles, feeds, and online dialogs. Examples of user interface 612 include web browsers, command line interfaces, and mobile app front ends. User interface 612 as used herein can include application programming interfaces (APIs).

Network 620 includes an electronic communications network. Network 620 can be implemented on any medium or mechanism that provides for the exchange of digital data, signals, and/or instructions between the various components of computing system 600. Examples of network 620 include, without limitation, a Local Area Network (LAN), a Wide Area Network (WAN), an Ethernet network or the Internet, or at least one terrestrial, satellite or wireless link, or a combination of any number of different networks and/or communication links.

Application software system 630 can include, for example, one or more online systems that provide social network services, general-purpose search engines, specific-purpose search engines, messaging systems, content distribution platforms, e-commerce software, enterprise software, or any combination of any of the foregoing or other types of software. Application software system 630 includes any type of application software system that provides or enables the creation of and interactions with at least one form of digital content, including machine-generated content, between or among user systems, such as user system 610, via user interface 612. For example, each or any of app1 120, app2 122, appN 124, and/or GAI system 130 can be an application software system 630. In some implementations, portions of interface engine 680 are components of application software system 630. An application software system 630 can include one or more of an entity graph 632 and/or knowledge graph 634, a user connection network 636, a content distribution service 638, a search engine 640, and/or one or more modeling systems 642.

In some implementations, a front end portion of application software system 630 can operate in user system 610, for example as a plugin or widget in a graphical user interface of a web application, mobile software application, or as a web browser executing user interface 612. In an embodiment, a mobile app or a web browser of a user system 610 can transmit a network communication such as an HTTP request over network 620 in response to user input that is received through a user interface provided by the web application, mobile app, or web browser, such as user interface 612. A server running application software system 630 can receive the input from the web application, mobile app, or browser executing user interface 612, perform at least one operation using the input, and return output to the user interface 612 using a network communication such as an HTTP response, which the web application, mobile app, or browser receives and processes at the user system 610.

In the example of FIG. 6, an application software system 630 (e.g., app1 120, app2 122, appN 124, and/or GAI system 130) includes an entity graph 632 and/or a knowledge graph 634. Entity graph 632 and/or knowledge graph 634 include data organized according to graph-based data structures that can be traversed via queries and/or indexes to determine relationships between entities. For instance, entity graph 632 and/or knowledge graph 634 can be used to compute various types of relationship weights, affinity scores, similarity measurements, and/or statistics between, among, or relating to entities.

Entity graph 632, knowledge graph 634 includes a graph-based representation of data stored in data storage system 660, described herein. For example, entity graph 632, knowledge graph 634 represents entities, such as users, organizations (e.g., companies, schools, institutions), and content items (e.g., job postings, announcements, articles, comments, and shares, as nodes of a graph. Entity graph 632, knowledge graph 634 represents relationships, also referred to as mappings or links, between or among entities as edges, or combinations of edges, between the nodes of the graph. In some implementations, mappings between different pieces of data used by an application software system 630 are represented by one or more entity graphs. In some implementations, the edges, mappings, or links indicate online interactions or activities relating to the entities connected by the edges, mappings, or links. For example, if a user views a feed item, an edge may be created connecting the user entity with the feed item entity in the entity graph, where the edge may be tagged with a label such as “viewed.” As another example, if a user applies for a job, an edge may be created connecting the user entity with the job entity in the entity graph, where the edge may be tagged with a label such as “applied.”

Portions of entity graph 632, knowledge graph 634 can be automatically re-generated or updated from time to time based on changes and updates to the stored data, e.g., updates to entity data and/or activity data. Also, entity graph 632, knowledge graph 634 can refer to an entire system-wide entity graph or to only a portion of a system-wide graph. For instance, entity graph 632, knowledge graph 634 can refer to a subset of a system-wide graph, where the subset pertains to a particular user or group of users of application software system 630.

Knowledge graph 634 includes a graph-based representation of data stored in data storage system 660, described herein. Knowledge graph 634 represents relationships, also referred to as links or mappings, between entities or concepts as edges, or combinations of edges, between the nodes of the graph. In some implementations, mappings between different pieces of data used by application software system 630 or across multiple different application software systems are represented by the knowledge graph 634.

In some implementations, knowledge graph 634 is a subset or a superset of entity graph 632. For example, in some implementations, knowledge graph 634 includes multiple different entity graphs 632 that are joined by cross-application or cross-domain edges. For instance, knowledge graph 634 can join entity graphs 632 that have been created across multiple different databases or across different software products. In some implementations, the entity nodes of the knowledge graph 634 represent concepts, such as product surfaces, verticals, or application domains. In some implementations, knowledge graph 634 includes a platform that extracts and stores different concepts that can be used to establish links between data across multiple different software applications. Examples of concepts include topics, industries, and skills. The knowledge graph 634 can be used to generate and export content and entity-level embeddings that can be used to discover or infer new interrelationships between entities and/or concepts, which then can be used to identify related entities. As with other portions of entity graph 632, knowledge graph 634 can be used to compute various types of relationship weights, affinity scores, similarity measurements, and/or statistical correlations between or among entities and/or concepts.

In the example of FIG. 6, application software system 630 includes a user connection network 636. User connection network 636 includes, for instance, a social network service, professional social network system and/or other social graph-based applications. Content distribution service 638 includes, for example, a chatbot or chat-style system, a messaging system, such as a peer-to-peer messaging system that enables the creation and exchange of messages among users of application software system 630, or a news feed. Search engine 640 includes a search engine that enables users of application software system 630 to input and execute search queries on user connection network 636 and/or entity graph 632 and/or knowledge graph 634.

In the example of FIG. 6, application software system 630 includes a content distribution service 638. The content distribution service 638 can include a data storage service, such as a web server, which stores digital content items, and transmits digital content items to users via user interface 612. In some embodiments, content distribution service 638 processes requests from, for example, application software system 630 and/or interface engine 680, and distributes digital content items to user systems 610 in response to requests. A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, or a page load. In some implementations, content distribution service 638 is part of application software system 630. In other implementations, content distribution service 638 interfaces with application software system 630 and/or interface engine 680, for example, via one or more application programming interfaces (APIs).

In the example of FIG. 6, application software system 630 includes a search engine 640. Search engine 640 includes a software system designed to search for and retrieve information by executing queries on data stores, such as databases, connection networks, and/or graphs. The queries are designed to find information that matches specified criteria, such as keywords and phrases. For example, search engine 640 is used to retrieve data by executing queries on various data stores of data storage system 660 or by traversing entity graph 632, 634.

The interface engine 680 facilitates exchanges of contextual information between or among different applications (e.g., app1 120, app2 122, appN 124, and/or GAI system 130) at runtime (e.g., while the applications are in online use). For example, as described in more detail herein, interface engine 680 enables contextual data generated in one application (e.g., a news feed or social network) to be used as input to a generative artificial intelligence (GAI) model associated with another application (e.g., a chatbot). Alternatively or in addition, interface engine enables output of a GAI model presented via one application (e.g., a chatbot) to be used as contextual data in another application (e.g., a news feed or social network).

In the example of FIG. 6, application software system 630 can include or interface with one or more modeling systems 642. A modeling system 632 includes one or more models 644 and one or more model creator/trainers 646. Examples of models 644 include artificial intelligence-based models such as one or more of probabilistic models, statistical models, machine learning models, neural networks, discriminative models, or generative models. For instance, models 644 can include one or more machine learning-based classification models and/or scoring models, such as models that generate recommendations for users of online systems, e.g., content recommendations, connection recommendations, input recommendations, etc.

Model creator/trainer 646 includes one or more automated components that receive data from one or more other systems or applications and create training data for one or more of the models 644 based on the received data. The model creator/trainer 646 applies the respective training data to the respective models 644 to create, train, or tune the respective models 644. In some embodiments, the model creator/trainer 646 communicates with interface engine 680, for example, to receive, from interface engine 680, current and/or historical application context data and/or user-specific context data obtained by interface engine 680 from one or more application software systems such as the first application or second software application described above. Based on the context data received from interface engine 680, model creator/trainer 646 formulates one or more instances of training data and applies one or more models 644 to the training data that has been formulated based on the context data received from interface engine 680. In this way, one or more models 644, which may support a third application, e.g., a recommendation system, can be trained or tuned based on context data obtained by interface engine 680 from one or more other applications.

Event logging service 670 captures and records network activity data generated during operation of application software system 630 and/or interface engine 680, including user interface events generated at user systems 610 via user interface 612, in real time, and formulates the user interface events into a data stream that can be consumed by, for example, a stream processing system. Examples of network activity data include thread creations, thread edits, thread views, page loads, clicks on messages or graphical user interface control elements, the creation, editing, sending, and viewing of content items such as posts, articles, job postings, and messages, and social action data such as likes, shares, comments, and social reactions (e.g., “insightful,” “curious,” etc.). For instance, when a user of application software system 630 via a user system 610 enters input or clicks on a user interface element, such as a message, a link, or a user interface control element such as a view, comment, share, or reaction button, or uploads a file, or creates a message, loads a web page, or scrolls through a feed, etc., event logging service 670 fires an event to capture and store log data including an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web or mobile.

For instance, when a user enters input or reacts to system-generated output, event logging service 670 stores the corresponding event data in a log. Event logging service 670 generates a data stream that includes a record of real-time event data for each user interface event that has occurred. Event data logged by event logging service 670 can be pre-processed and anonymized as needed so that it can be used, for example, to generate relationship weights, affinity scores, similarity measurements, and/or to formulate training data for artificial intelligence models.

Data storage system 660 includes data stores and/or data services that store digital data received, used, manipulated, and produced by application software system 630 and/or interface engine 680, including contextual data, state data, prompts, user inputs, system-generated outputs, metadata, attribute data, activity data, machine learning model training data, machine learning model parameters, and machine learning model inputs and outputs, such as machine-generated classifications, scores, or machine-generated digital content.

In the example of FIG. 6, data storage system 660 includes an entity data store 662, an activity data store 664, a prompt data store 666, and a state data store 668. Entity data store 662 stores data relating to users, companies, jobs, and other entities, such as profile data. Activity data store 664 stores data relating to network activity, e.g., user interface event data extracted from one or more application software systems 630 and/or interface engine 680 by event logging service 670. Prompt data store 666 stores prompt templates and/or prompts which include one or more instructions for a GAI model. State store 668 stores data relating to the current state of a user system including the current state of various applications that may be running on the user system, such as the current state of app1 120, app2 122, appN 124, and/or GAI system 130. While shown in FIG. 6 as components of a data storage system 660, all or portions of each or any of the entity data store 662, activity data store 664, prompt data store 666, and/or state data store 668 are implemented on the user system 610 in some embodiments. For example, state data store 668 includes a volatile memory such as a form of random access memory (RAM) available on user system 610 for storing state data generated by the user system 610. As another example, in some implementations, a separate, personalized version of each or any of the entity data store 662, activity data store 664, prompt data store 666, and/or state data store 668 is created for each user such that data is not shared between or among the separate, personalized versions of the data stores.

In some embodiments, data storage system 660 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of data storage system 660 can be configured to store data produced by real-time and/or offline (e.g., batch) data processing. A data store configured for real-time data processing can be referred to as a real-time data store. A data store configured for offline or batch data processing can be referred to as an offline data store. Data stores can be implemented using databases, such as key-value stores, relational databases, and/or graph databases. Data can be written to and read from data stores using query technologies, e.g., SQL or NoSQL.

A key-value database, or key-value store, is a nonrelational database that organizes and stores data records as key-value pairs. The key uniquely identifies the data record, i.e., the value associated with the key. The value associated with a given key can be, e.g., a single data value, a list of data values, or another key-value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

Data storage system 660 resides on at least one persistent and/or volatile storage device that can reside within the same local network as at least one other device of computing system 600 and/or in a network that is remote relative to at least one other device of computing system 600. Thus, although depicted as being included in computing system 600, portions of data storage system 660 can be part of computing system 600 or accessed by computing system 600 over a network, such as network 620.

While not specifically shown, it should be understood that any of user system 610, application software system 630, interface engine 680, data storage system 660, and event logging service 670 includes an interface embodied as computer programming code stored in computer memory that when executed causes a computing device to enable bidirectional communication with any other of user system 610, application software system 630, interface engine 680, data storage system 660, or event logging service 670 using a communicative coupling mechanism. Examples of communicative coupling mechanisms include network interfaces, inter-process communication (IPC) interfaces and application program interfaces (APIs).

Each of user system 610, application software system 630, interface engine 680, data storage system 660, and event logging service 670 is implemented using at least one computing device that is communicatively coupled to electronic communications network 620. Any of user system 610, application software system 630, interface engine 680, data storage system 660, and event logging service 670 can be bidirectionally communicatively coupled by network 620. User system 610 as well as other different user systems (not shown) can be bidirectionally communicatively coupled to application software system 630 and/or interface engine 680.

A typical user of user system 610 can be an administrator or end user of application software system 630 or interface engine 680. User system 610 is configured to communicate bidirectionally with any of application software system 630, interface engine 680, data storage system 660, and event logging service 670 over network 620.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 610, application software system 630, interface engine 680, data storage system 660, and event logging service 670 are implemented using computer software, hardware, or software and hardware, and can include combinations of automated functionality, data structures, and digital data, which are represented schematically in the figures. User system 610, application software system 630, interface engine 680, data storage system 660, and event logging service 670 are shown as separate elements in FIG. 6 for ease of discussion but, except as otherwise described, the illustration is not meant to imply that separation of these elements is required. The illustrated systems, services, and data stores (or their functionality) of each of user system 610, application software system 630, interface engine 680, data storage system 660, and event logging service 670 can be divided over any number of physical systems, including a single physical computer system, and can communicate with each other in any appropriate manner.

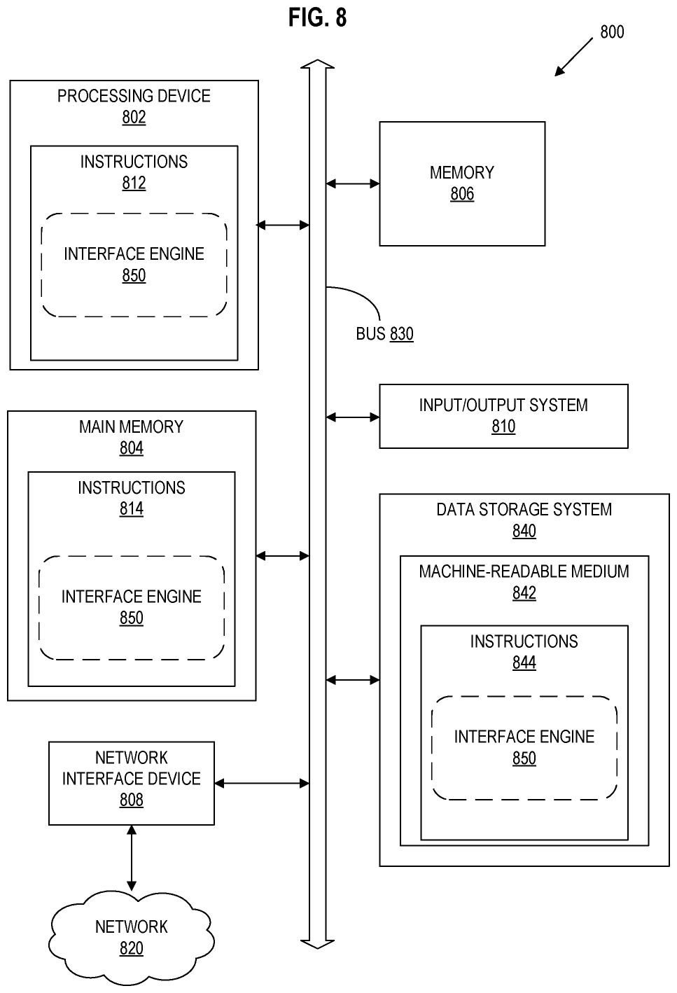

In the embodiment of FIG. 8, portions of interface engine 680 that may be implemented on a front end system, such as one or more user systems, and portions of interface engine 680 that may be implemented on a back end system such as one or more servers, are collectively represented as interface engine 850 for case of discussion only. For example, portions of interface engine 680 are not required to be implemented all on the same computing device, in the same memory, or loaded into the same memory at the same time. For instance, access to portions of interface engine 680 can be limited to different, mutually exclusive sets of user systems and/or servers. For instance, in some implementations, a separate, personalized version of interface engine 680 is created for each user of the interface engine 680 such that data is not shared between or among the separate, personalized versions of the interface engine 680. Additionally, certain portions of interface engine 680 typically may be implemented on user systems while other portions of interface engine 680 typically may be implemented on a server computer or group of servers. In some embodiments, however, one or more portions of interface engine 680 are implemented on user systems. For example, interface engine 680 is entirely implemented on user systems, e.g., client devices, in some implementations. Further details with regard to the operations of interface engine 850 are described herein.

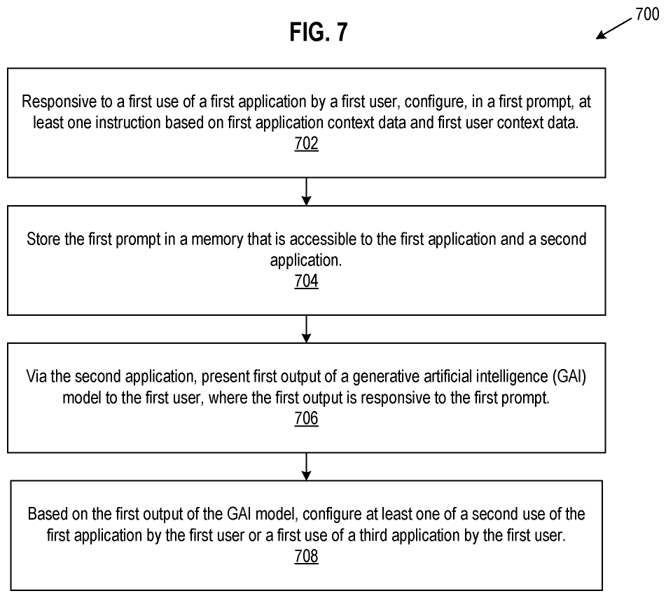

FIG. 7 is a flow diagram of an example method for providing an interface between or among one or more applications and a generative artificial intelligence model using components of an interface engine in accordance with some embodiments of the present disclosure.

The method 700 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by one or more components of interface engine 104 of FIG. 1 or interface engine 680 of FIG. 6. For example, in some implementations, portions of the method 700 are performed by one or more components of an interface engine shown in FIG. 1 and/or FIG. 5, described herein. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 702, the processing device, responsive to a first use of a first application by a first user, configures, in a first prompt, at least one instruction based on first application context data and first user context data. In some implementations, the first application context data is included in the first use of the first application by the first user. Operation 702 is performed, for example, by the context switcher 108 and/or the contextual data fetcher 112 of the embodiment of the interface engine 104 shown in FIG. 1 or FIG. 2, described herein.

At operation 704, the processing device stores the first prompt in a memory that is accessible to the first application and a second application. Operation 702 is performed, for example, by the context switcher 108 and/or the state tracker 110 of the embodiment of interface engine 104 shown in FIG. 1 or FIG. 2, described herein.

At operation 706, the processing device, via the second application, presents first output of a generative artificial intelligence (GAI) model to the first user, where the first output is responsive to the first prompt. In some implementations, the first output is based on at least the first user context data. Operation 706 is performed, for example, by the context switcher 108 and/or a second application (e.g., App2 122 or AppN 124) of the embodiment of interface engine 104 shown in FIG. 1 or FIG. 2, described herein.

At operation 708, the processing device, based on the first output of the GAI model, configures at least one of a second use of the first application by the first user or a first use of a third application by the first user. In some implementations, the third application is different from the first application and the second application. Operation 708 is performed, for example, by the context switcher 108 and/or a another application (e.g., App1 120, App2 122 or AppN 124) of the embodiment of interface engine 104 shown in FIG. 1 or FIG. 2, described herein.

In some implementations, operation 702 includes configuring in the first prompt, at least one instruction based on an intent of the first user, wherein the intent is extracted from the first use of the first application by the first user.

In some implementations, operation 702 includes configuring, in the first prompt, at least one instruction based on a content item presented to the first user via the first application during the first use of the first application by the first user.

In some implementations, operation 702 includes configuring, in the first prompt, at least one instruction based on at least one of profile data associated with the first user by the first application or historical interaction data associated with the first user and the first application.

In some implementations, operation 702 includes configuring the first prompt in response to a signal received via a user interface element of the first application.

In some implementations, the processing device, via the first application, responsive to determining that a content item presented to the first user during the first use of the first application by the first user satisfies at least one criterion related to the GAI model, links the user interface element with the content item.

In some implementations, the processing device, responsive to the first use of the third application by the first user, configures, in a second prompt, at least one instruction based on the third application context, where the third application context data is included in the first use of the third application by the first user, stores the second prompt in a memory that is accessible to the third application and the second application, and via the second application, presents second output of the GAI model to the first user, where the second output is responsive to the second prompt and the second output is based on at least the third application context data.

In some implementations, the processing device, responsive to a second use of the first application by the first user, configures, in a third prompt, at least one instruction based on at least one interaction of the first user with a content item presented to the first user via the first application during the second use of the first application by the first user, stores the third prompt in the memory that is accessible to the first application and the second application, and via the second application, presents third output of the GAI model to the first user, where the third output is responsive to the third prompt and the third output is based on the at least one interaction of the first user with the content item presented to the first user via the first application during the second use of the first application by the first user.

In some implementations, the processing device, responsive to at least one interaction of the first user with the first output of the GAI model in the second application, stores, in the memory accessible to the first application and the second application, data associated with the at least one interaction of the first user with the first output of the GAI model in the second application, and responsive to a second use of the first application by the first user, provides, to the first application, the data associated with the at least one interaction of the first user with the first output of the GAI model in the second application.

In some implementations, the processing device configures a preference of the first user in the first application based on the data associated with the at least one interaction of the first user with the first output of the GAI model in the second application.

The examples shown in FIG. 7 and the accompanying description, above are provided for illustration purposes. This disclosure is not limited to the described examples.

FIG. 8 is a block diagram of an example computer system including components of a an interface engine in accordance with some embodiments of the present disclosure.

In FIG. 8, an example machine of a computer system 800 is shown, within which a set of instructions for causing the machine to perform any of the methodologies discussed herein can be executed. In some embodiments, the computer system 800 can correspond to a component of a networked computer system (e.g., as a component of the computing system 100 of FIG. 1 or the computer system 600 of FIG. 6) that includes, is coupled to, or utilizes a machine to execute an operating system to perform operations corresponding to one or more components of the interface engine 104 of FIG. 1 or the interface engine 680 of FIG. 6. For example, computer system 800 corresponds to a portion of computing system 600 when the computing system is executing a portion of interface engine 104 or interface engine 680.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a memory 803 (e.g., flash memory, static random access memory (SRAM), etc.), an input/output system 810, and a data storage system 840, which communicate with each other via a bus 830.

Processing device 802 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be at least one special-purpose processing device such as an application specific integrated circuit (ASIC), a field programmable gate array (FPGA), a digital signal processor (DSP), network processor, or the like. The processing device 802 is configured to execute instructions 812 for performing the operations and steps discussed herein.

In some embodiments of FIG. 8, interface engine 850 represents portions of interface engine 680 while the computer system 800 is executing those portions of interface engine 680. Instructions 812 include portions of interface engine 850 when those portions of the interface engine 850 are being executed by processing device 802. Thus, the interface engine 850 is shown in dashed lines as part of instructions 812 to illustrate that, at times, portions of the interface engine 850 are executed by processing device 802. For example, when at least some portion of the interface engine 850 is embodied in instructions to cause processing device 802 to perform the method(s) described herein, some of those instructions can be read into processing device 802 (e.g., into an internal cache or other memory) from main memory 804 and/or data storage system 840. However, it is not required that all of the interface engine 850 be included in instructions 812 at the same time and portions of the interface engine 850 are stored in at least one other component of computer system 800 at other times, e.g., when at least one portion of the interface engine 850 are not being executed by processing device 802.

The computer system 800 further includes a network interface device 808 to communicate over the network 820. Network interface device 808 provides a two-way data communication coupling to a network. For example, network interface device 808 can be an integrated-services digital network (ISDN) card, cable modem, satellite modem, or a modem to provide a data communication connection to a corresponding type of telephone line. As another example, network interface device 808 can be a local area network (LAN) card to provide a data communication connection to a compatible LAN. Wireless links can also be implemented. In any such implementation network interface device 808 can send and receives electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 800.

Computer system 800 can send messages and receive data, including program code, through the network(s) and network interface device 808. In the Internet example, a server can transmit a requested code for an application program through the Internet and network interface device 808. The received code can be executed by processing device 802 as it is received, and/or stored in data storage system 840, or other non-volatile storage for later execution.

The input/output system 810 includes an output device, such as a display, for example a liquid crystal display (LCD) or a touchscreen display, for displaying information to a computer user, or a speaker, a haptic device, or another form of output device. The input/output system 810 can include an input device, for example, alphanumeric keys and other keys configured for communicating information and command selections to processing device 802. An input device can, alternatively or in addition, include a cursor control, such as a mouse, a trackball, or cursor direction keys for communicating direction information and command selections to processing device 802 and for controlling cursor movement on a display. An input device can, alternatively or in addition, include a microphone, a sensor, or an array of sensors, for communicating sensed information to processing device 802. Sensed information can include voice commands, audio signals, geographic location information, haptic information, and/or digital imagery, for example.

The data storage system 840 includes a machine-readable storage medium 842 (also known as a computer-readable medium) on which is stored at least one set of instructions 844 or software embodying any of the methodologies or functions described herein. The instructions 844 can also reside, completely or at least partially, within the main memory 804 and/or within the processing device 802 during execution thereof by the computer system 800, the main memory 804 and the processing device 802 also constituting machine-readable storage media. In one embodiment, the instructions 844 include instructions to implement functionality corresponding to an interface engine 850 (e.g., the interface engine 104 of FIG. 1 or interface engine 680 of FIG. 6).

Dashed lines are used in FIG. 8 to indicate that it is not required that the interface engine be embodied entirely in instructions 812, 814, and 844 at the same time. In one example, portions of the interface engine are embodied in instructions 814, which are read into main memory 804 as instructions 814, and portions of instructions 812 are read into processing device 802 as instructions 812 for execution. In another example, some portions of the interface engine are embodied in instructions 844 while other portions are embodied in instructions 814 and still other portions are embodied in instructions 812.

While the machine-readable storage medium 842 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media. The examples shown in FIG. 8 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100 or the computing system 600, can carry out the above-described computer-implemented methods in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples described herein, or any combination of any of the examples described herein, or any combination of any portions of the examples described herein.

In an example 1, a method includes: responsive to a first use of a first application by a first user, configuring, in a first prompt, at least one instruction based on first application context data and first user context data, where the first application context data is included in the first use of the first application by the first user; storing the first prompt in a memory that is accessible to the first application and a second application; via the second application, presenting first output of a generative artificial intelligence (GAI) model to the first user, where the first output is responsive to the first prompt and the first output is based on at least the first user context data; and based on the first output of the GAI model, configuring at least one of a second use of the first application by the first user or a first use of a third application by the first user, where the third application is different from the first application and the second application.

An example 2 includes the subject matter of any of the other examples, further including: configuring, in the first prompt, at least one instruction based on an intent of the first user, where the intent is extracted from the first use of the first application by the first user. An example 3 includes the subject matter of any of the other examples, further including: configuring, in the first prompt, at least one instruction based on a content item presented to the first user via the first application during the first use of the first application by the first user. An example 4 includes the subject matter of any of the other examples, further including: configuring, in the first prompt, at least one instruction based on at least one of profile data associated with the first user by the first application or historical interaction data associated with the first user and the first application. An example 5 includes the subject matter of any of the other examples, further including: configuring the first prompt in response to a signal received via a user interface element of the first application. An example 6 includes the subject matter of example 5 alone or in combination with any of the other examples, further including: via the first application, responsive to determining that a content item presented to the first user during the first use of the first application by the first user satisfies at least one criterion related to the GAI model, linking the user interface element with the content item. An example 7 includes the subject matter of any of the other examples, further including, responsive to the first use of the third application by the first user, configuring, in a second prompt, at least one instruction based on the third application context, where the third application context data is included in the first use of the third application by the first user; storing the second prompt in a memory that is accessible to the third application and the second application; and via the second application, presenting second output of the GAI model to the first user, where the second output is responsive to the second prompt and the second output is based on at least the third application context data. An example 8 includes the subject matter of any of the other examples, further including, responsive to a second use of the first application by the first user, configuring, in a third prompt, at least one instruction based on at least one interaction of the first user with a content item presented to the first user via the first application during the second use of the first application by the first user; storing the third prompt in the memory that is accessible to the first application and the second application; and via the second application, presenting third output of the GAI model to the first user, where the third output is responsive to the third prompt and the third output is based on the at least one interaction of the first user with the content item presented to the first user via the first application during the second use of the first application by the first user. An example 9 includes the subject matter of any of the other examples, further including, responsive to at least one interaction of the first user with the first output of the GAI model in the second application, storing, in the memory accessible to the first application and the second application, data associated with the at least one interaction of the first user with the first output of the GAI model in the second application; responsive to a second use of the first application by the first user, providing, to the first application, the data associated with the at least one interaction of the first user with the first output of the GAI model in the second application. An example 10 includes the subject matter of any of the other examples, further including, configuring a preference of the first user in the first application based on the data associated with the at least one interaction of the first user with the first output of the GAI model in the second application. An example 11 includes the method of any of the preceding examples, further including any one or more aspects, steps, components, elements, processes, or limitations that are at least one of described in the enclosed description or shown in the accompanying drawings. An example 12 includes a system, including: at least one processor; and at least one memory coupled to the at least one processor, where the at least one memory includes instructions that, when executed by the at least one processor, cause the at least one processor to perform at least one operation including the method of any of examples 1-11. An example 13 includes at least one non-transitory machine-readable storage medium, including instructions that, when executed by at least one processor, cause the at least one processor to perform at least one operation including the method of any of examples 1-11.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
responsive to a first use of a first application by a first user, configuring, in a first prompt, at least one instruction based on first application context data and first user context data, wherein the first application context data is included in the first use of the first application by the first user;
storing the first prompt in a memory that is accessible to the first application and a second application;
via the second application, presenting first output of a generative artificial intelligence (GAI) model to the first user, wherein the first output is responsive to the first prompt and the first output is based on at least the first user context data; and
based on the first output of the GAI model, configuring at least one of a second use of the first application by the first user or a first use of a third application by the first user, wherein the third application is different from the first application and the second application.

2. The method of claim 1, further comprising:
configuring, in the first prompt, at least one instruction based on an intent of the first user, wherein the intent is extracted from the first use of the first application by the first user.

3. The method of claim 1, further comprising:
configuring, in the first prompt, at least one instruction based on a content item presented to the first user via the first application during the first use of the first application by the first user.

4. The method of claim 1, further comprising:
configuring, in the first prompt, at least one instruction based on at least one of profile data associated with the first user by the first application or historical interaction data associated with the first user and the first application.

5. The method of claim 1, further comprising:
configuring the first prompt in response to a signal received via a user interface element of the first application.

6. The method of claim 5, further comprising:
via the first application, responsive to determining that a content item presented to the first user during the first use of the first application by the first user satisfies at least one criterion related to the GAI model, linking the user interface element with the content item.

7. The method of claim 1, further comprising,
responsive to the first use of the third application by the first user, configuring, in a second prompt, at least one instruction based on third application context data, wherein the third application context data is included in the first use of the third application by the first user;
storing the second prompt in a memory that is accessible to the third application and the second application; and
via the second application, presenting second output of the GAI model to the first user, wherein the second output is responsive to the second prompt and the second output is based on at least the third application context data.

8. The method of claim 1, further comprising,
responsive to a second use of the first application by the first user, configuring, in a third prompt, at least one instruction based on at least one interaction of the first user with a content item presented to the first user via the first application during the second use of the first application by the first user;
storing the third prompt in the memory that is accessible to the first application and the second application; and
via the second application, presenting third output of the GAI model to the first user, wherein the third output is responsive to the third prompt and the third output is based on the at least one interaction of the first user with the content item presented to the first user via the first application during the second use of the first application by the first user.

9. The method of claim 1, further comprising,
responsive to at least one interaction of the first user with the first output of the GAI model in the second application, storing, in the memory accessible to the first application and the second application, data associated with the at least one interaction of the first user with the first output of the GAI model in the second application; and
responsive to a second use of the first application by the first user, providing, to the first application, the data associated with the at least one interaction of the first user with the first output of the GAI model in the second application.

10. The method of claim 9, further comprising,
configuring a preference of the first user in the first application based on the data associated with the at least one interaction of the first user with the first output of the GAI model in the second application.

11. A system comprising:
at least one processor; and
at least one memory coupled to the at least one processor, wherein the at least one memory comprises instructions that, when executed by the at least one processor, cause the at least one processor to perform at least one operation comprising:
responsive to a first use of a first application by a first user, configuring, in a first prompt, at least one instruction based on first application context data and first user context data, wherein the first application context data is included in the first use of the first application by the first user;
storing the first prompt in a memory that is accessible to the first application and a second application;
via the second application, presenting first output of a generative artificial intelligence (GAI) model to the first user, wherein the first output is responsive to the first prompt and the first output is based on at least the first user context data; and
based on the first output of the GAI model, configuring at least one of a second use of the first application by the first user or a first use of a third application by the first user, wherein the third application is different from the first application and the second application.

12. The system of claim 11, wherein the instructions, when executed by the at least one processor, cause the at least one processor to perform at least one operation further comprising:
configuring, in the first prompt, at least one instruction based on an intent of the first user, wherein the intent is extracted from the first use of the first application by the first user.

13. The system of claim 11, wherein the instructions, when executed by the at least one processor, cause the at least one processor to perform at least one operation further comprising:
configuring, in the first prompt, at least one instruction based on a content item presented to the first user via the first application during the first use of the first application by the first user.

14. The system of claim 11, wherein the instructions, when executed by the at least one processor, cause the at least one processor to perform at least one operation further comprising:
configuring, in the first prompt, at least one instruction based on at least one of profile data associated with the first user by the first application or historical interaction data associated with the first user and the first application.

15. The system of claim 11, wherein the instructions, when executed by the at least one processor, cause the at least one processor to perform at least one operation further comprising:
configuring the first prompt in response to a signal received via a user interface element of the first application; and
via the first application, responsive to determining that a content item presented to the first user during the first use of the first application by the first user satisfies at least one criterion related to the GAI model, linking the user interface element with the content item.

16. At least one non-transitory machine-readable storage medium comprising instructions that, when executed by at least one processor, cause the at least one processor to perform at least one operation comprising:
responsive to a first use of a first application by a first user, configuring, in a first prompt, at least one instruction based on first application context data and first user context data, wherein the first application context data is included in the first use of the first application by the first user;
storing the first prompt in a memory that is accessible to the first application and a second application;
via the second application, presenting first output of a generative artificial intelligence (GAI) model to the first user, wherein the first output is responsive to the first prompt and the first output is based on at least the first user context data; and
based on the first output of the GAI model, configuring at least one of a second use of the first application by the first user or a first use of a third application by the first user, wherein the third application is different from the first application and the second application.

17. The at least one non-transitory machine-readable storage medium of claim 16, wherein the instructions, when executed by the at least one processor, cause the at least one processor to perform at least one operation further comprising:
configuring, in the first prompt, at least one instruction based on an intent of the first user, wherein the intent is extracted from the first use of the first application by the first user;
configuring, in the first prompt, at least one instruction based on a content item presented to the first user via the first application during the first use of the first application by the first user;
configuring, in the first prompt, at least one instruction based on at least one of profile data associated with the first user by the first application or historical interaction data associated with the first user and the first application;
configuring the first prompt in response to a signal received via a user interface element of the first application; and
via the first application, responsive to determining that a content item presented to the first user during the first use of the first application by the first user satisfies at least one criterion related to the GAI model, linking the user interface element with the content item.

18. The at least one non-transitory machine-readable storage medium of claim 16, wherein the instructions, when executed by the at least one processor, cause the at least one processor to perform at least one operation further comprising:
responsive to the first use of the third application by the first user, configuring, in a second prompt, at least one instruction based on third application context data, wherein the third application context data is included in the first use of the third application by the first user;
storing the second prompt in a memory that is accessible to the third application and the second application; and
via the second application, presenting second output of the GAI model to the first user, wherein the second output is responsive to the second prompt and the second output is based on at least the third application context data.

19. The at least one non-transitory machine-readable storage medium of claim 16, wherein the instructions, when executed by the at least one processor, cause the at least one processor to perform at least one operation further comprising:
responsive to a second use of the first application by the first user, configuring, in a third prompt, at least one instruction based on at least one interaction of the first user with a content item presented to the first user via the first application during the second use of the first application by the first user;
storing the third prompt in the memory that is accessible to the first application and the second application; and
via the second application, presenting third output of the GAI model to the first user, wherein the third output is responsive to the third prompt and the third output is based on the at least one interaction of the first user with the content item presented to the first user via the first application during the second use of the first application by the first user.

20. The at least one non-transitory machine-readable storage medium of claim 16, wherein the instructions, when executed by the at least one processor, cause the at least one processor to perform at least one operation further comprising:
responsive to at least one interaction of the first user with the first output of the GAI model in the second application, storing, in the memory accessible to the first application and the second application, data associated with the at least one interaction of the first user with the first output of the GAI model in the second application;
responsive to a second use of the first application by the first user, providing, to the first application, the data associated with the at least one interaction of the first user with the first output of the GAI model in the second application; and
configuring a preference of the first user in the first application based on the data associated with the at least one interaction of the first user with the first output of the GAI model in the second application.
